(19) United States
(12) Patent Application Publication
(10) Pub. No.: US 2026/0344703 A1
(43) Pub. Date: Nov. 5, 2026

(54) MYCOTOXIN-REDUCED ANIMAL FEED COMPOSITIONS

(71) Applicant: Cargill, Incorporated, Wayzata, MN (US)

(72) Inventors: Charles Philip Anderson, Blair, NE (US); Robert Joshua Brower, III, Clayton, OH (US); Hadi Nayef Yehia, Beavercreek, OH (US)

(73) Assignee: Cargill, Incorporated, Wayzata, MN (US)

(21) Appl. No.: 19/113,944

(22) PCT Filed: Sep. 21, 2023
(86) PCT No.: PCT/US2023/074728

§ 371 Date: Mar. 21, 2025

Related U.S. Application Data
(60) Provisional application No. 63/376,832, filed on Sep. 23, 2022.

(51) Int. Cl. A23K 10/12; A23K 10/14; A23K 10/30; A23K 20/20

(52) U.S. Cl. CPC A23K 10/12; A23K 10/14; A23K 10/30; A23K 20/20

(57) ABSTRACT

The invention covers a feed ingredient comprising one or more organic acids, one or more proteins, less than 10 ppm of mycotoxins based on total weight of the feed ingredient, at least 0.1 ppm of sulfonated mycotoxins and derivatives thereof based on total weight of the feed ingredient, and optionally degradation compounds of the sulfonated mycotoxins. Furthermore, the invention covers a process for preparing such feed ingredient comprising a step wherein a mycotoxin containing medium is treated with a bisulfite source (for instance SBS) to sulfonate the mycotoxins and render them non-toxic in the animal feed.

### CROSS-REFERENCE TO RELATED APPLICATIONS

This application claims the benefit of U.S. Application No. 63/376,832, filed Sep. 23, 2022, which is incorporated by reference herein in its entirety.

### FIELD OF THE INVENTION

The invention relates to reducing mycotoxin in fermented vegetable protein compositions, in particular fermented corn protein compositions.

### BACKGROUND OF THE INVENTION

The use of concentrated protein sources is desirable in aquaculture diets in order to address nutritional needs in a metabolizable nutrient dense package. This is especially true in organisms with a simple alimentary canal and rapid transit of feedstuffs through the gastrointestinal system. Shrimp exhibit such a system, and a high protein, low carbohydrate diet is advantageous for shrimp. Additionally, shrimp species may have the capabilities to utilize lactic acid or other organic acids to improve enzymatic digestibility and balance gut pH. Additionally, decreasing the luminal pH in shrimp through the addition of lactic acid may improve shrimp health, survivability, and productivity.

Therefore, fermented vegetable protein (FVP) compositions are highly desirable for use in animal feed (also referred to herein simply as “feed”). Such products have been disclosed by the applicant in WO17112841A1. The fermentation process entails a fermentation step that utilizes a steeping water, lactobacillus microorganisms, and a dextrose source to produce lactic acid and other key metabolites which are essential to maintaining gut pH and health in animals, such as shrimp. Generally, corn protein is the preferred vegetable protein that is fermented.

However, the production of animal feeds can be jeopardized if the raw materials (i.e., the crop, e.g., corn) contain elevated levels of mycotoxins, like deoxynivalenol (also referred to herein as DON or vomitoxin). Separation and concentration of different plant components may increase the levels of mycotoxins in these fractions due to physical or chemical affinity with different process streams. Elevated mycotoxins in the plant raw material, but also in the steeping water from various process streams from processing plant matter (e.g., vegetables, fruit, pulses or grains, like corn, wheat or rice), can quickly cause the mycotoxin concentrations in the final ingredient to be higher than regulatory laws and the product specifications allow.

This risk was particularly relevant for Cargill Branded Feed's Motiv® product, which is derived from corn wet milling streams, and is used in shrimp feed. Such streams are often infected with mycotoxin producing Fusarium molds. Current unit operations within the corn wet milling process are typically not able to mitigate these mycotoxin concerns in feed (with the exception of the corn float process), as depending on the chemical properties (hydrophilicity or hydrophobicity) of the specific mycotoxin in question, the toxin will concentrate in one of the final streams coming out of the wet mill (cracked corn, gluten, bran, or steepwater). Seasonal differences in fungal infections in the US corn crop can lead to major customer impacts and production disruptions. If mycotoxin levels are elevated in feed products, a myriad of issues are encountered in the animals consuming the feed as a primary portion of their overall diets.

Thus, there was a need to find a quick, cheap and effective solution to properly mitigate mycotoxin associated risks in animal feed products, in particular fermented vegetable protein containing products, such as animal feed ingredients (also referred to herein simply as “feed ingredients”), animal feed products (also referred to herein simply as “feed products”) and animal feed diets (also referred to herein simply as “feed diets”).

### SUMMARY OF THE INVENTION

The present invention relates to feed ingredients, feed products containing such feed ingredients, and feed diets containing such feed products or ingredients.

The compositions and methods described herein are particularly useful for use in feed for aquaculture, such as for farmed shrimp. However, the compositions and methods are not limited to shrimp and can be used for feeding any animal that can tolerate the sulfur content present in the feed ingredient, for instance poultry and swine.

The present invention also relates to a feed ingredient that is a high in protein and organic acid. Accordingly, the feed ingredient or product of the present invention can include one or more organic acids and is rich in amino acids. The feed ingredient or product can be produced using a fermentation process, for example through the fermentation of a vegetable mill stream, resulting in a fermented vegetable protein. The concentration of mycotoxins in the feed ingredient is less than 10 ppm. Preferably, the feed ingredient can have less than 5 ppm, less than 2 ppm, less than 1.5 ppm, less than 1 ppm, less than 0.5 ppm of mycotoxins, based on total weight of the feed ingredient.

The concentration of sulfonated mycotoxins and derivatives in the feed ingredient is at least 0.1 ppm. The feed ingredient can have at least 0.2 ppm, or at least 0.5 ppm, or at least 1 ppm, or at least 2 ppm of sulfonated mycotoxins and derivatives thereof, based on total weight of the feed ingredient.

The feed ingredient may optionally also contain degradation compounds of the sulfonated mycotoxins.

In particular, the mycotoxins present in the raw material prior to fermentation are DON. Thus, the concentration of DON in the feed ingredient according to the invention is less than 10 ppm, less than 5 ppm, less than 2 ppm, less than 1.5 ppm, less than 1 ppm, less than 0.5 ppm of DON, based on total weight of the feed ingredient. The concentration of DON-S (i.e., sulfonated DON) and derivates thereof in the feed ingredient is at least 0.1 ppm, or at least 0.2 ppm, or at least 0.5 ppm, or at least 1 ppm, or at least 2 ppm, based on the total weight of the feed ingredient. The feed ingredient may also contain degradation compounds of DON-S.

In one aspect, a feed ingredient is described, comprising: one or more organic acids, one or more proteins, optionally phosphorus, optionally (less than 0.6 wt. percent) phytic acid, less than 10 ppm of mycotoxins e.g., DON, and at least 0.1 ppm of sulfonated mycotoxins and derivatives thereof e.g., DON-S and derivatives thereof. The feed ingredient may optionally also contain degradation compounds of the sulfonated mycotoxins, in particular of DON-S.

The one or more proteins in the feed ingredient may comprise or essentially consist of corn protein. That corn protein may be fermented corn protein.

The mycotoxins in the feed ingredient may be deoxynivalenol (DON) and the sulfonated mycotoxins in the feed ingredient may be sulfonated deoxynivalenol (DON-S).

The feed ingredient may have degradation compounds of the sulfonated mycotoxins, in particular of DON-S.

The DON-S present in the feed ingredient are generally in the form of one or more of compound (a) “10-DON sulfonate”, compound (b) “8-DON sulfonate”, and derivatives thereof.

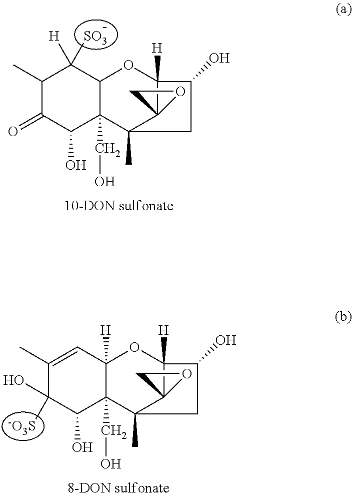

The feed ingredient may contain degradation compounds of DON-S selected from one or more of the following:

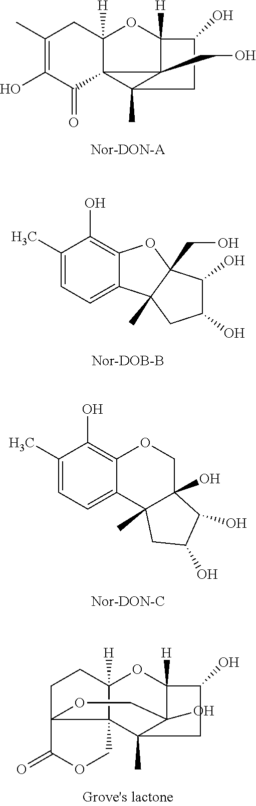

Other degradation compounds in the feed ingredient may also include one or more of the following compounds: Nor-DON-D, Nor-DON-E, Nor-DON-F, Nor-DON-G, and Nor-DON-H.

The one or more organic acids can be selected from the group consisting of lactic acid, formic acid, propionic acid, fumaric acid, citric acid, butyric acid, gluconic acid, itaconic acid, pyruvic acid, salts thereof, and any combination of these organic acids or salts thereof. The one or more organic acids can be present in an amount suitable for reducing the gastric pH of an animal. The one or more organic acids can be present in an amount of about 45 to 50 wt percent dry basis. In one aspect, the one or more proteins are derived from any vegetable source, including, but not limited to, any stream from a grain milling process or grain fermentation process, for instance from corn wet milling. The one or more proteins can for instance include corn protein. The one or more proteins can be present in an amount of about 25 to 35 wt percent dry basis.

The feed ingredient can include 4.0 to 6.0 wt percent free phosphate on dry basis and/or 38 to 43 wt percent lactic acid on dry basis. The feed ingredient may have less than 2 wt percent of sugars on dry basis. The feed ingredient may have at least 40 percent dry solids.

A feed product is described, comprising one or more of the feed ingredients described herein. The feed product may further include a vegetable protein concentrate, such as corn protein concentrate. The feed product may further include corn gluten meal. The phytic acid content of the feed product may be less than 0.6 wt percent dry basis. The feed product may have an organic acid content of about 8.0 to 9.0 wt percent dry basis. The feed product may comprise 72 to 76 wt percent protein dry basis; 3.0 to 3.6 wt percent lysine dry basis; 6 to 8 wt percent lactic acid dry basis; and/or 4.0 to 6.0 wt percent free phosphate on dry basis. The feed product may have less than 2 wt percent of sugars on dry basis. The feed product may have a moisture content of less than 9 percent. In particular the concentration of mycotoxins, in particular DON, in the feed product is less than 10 ppm, based on total weight of the feed product. The concentration of sulfonated mycotoxins and derivatives, in particular DON-S (i.e., sulfonated DON) and derivatives thereof, in the feed product is at least 0.1 ppm, based on total weight of the feed product. The feed product may also comprise degradation compounds of the sulfonated mycotoxins, in particular of DON-S.

A feed diet is described that comprises a feed ingredient and/or feed product of the present invention. The feed diet may comprise 2 to 24 percent of a feed product of the present invention. The feed diet may comprise 10 to 14 percent of a feed product of the present invention. The feed diet may further comprise a fat.

The feed ingredients, feed products, or feed diets of the present invention may be suitable for feeding an aquatic animal. Preferably, the aquatic animal is a shrimp.

A process for producing a feed ingredient according to the invention is described, comprising: providing a fermentation medium comprising one or more proteins and one or more sugars; fermenting the fermentation medium to produce a fermentation product, such as one or more organic acids; optionally adjusting the pH of the fermentation medium during fermentation; optionally adjusting the temperature of the fermentation medium during fermentation, optionally treating the fermentation medium to reduce an anti-nutritional factor (ANF), treating the fermentation medium with a source of bisulfite ions to reduce mycotoxins (sulfonation treatment) and concentrating the fermentation medium and obtaining the feed ingredient. The treatment of the fermentation medium with a source of bisulfite ions can take place at later stages after the fermentation step and any ANF reduction treatment step (e.g., phytase treatment), preferably after the pH has been adjusted (pH 4.5-5.0, e.g., pH 4.5, 4.75, or 5.0) to maintain a healthy bacterial count e.g., either before, during or after the concentration step to produce a feed ingredient.

The SO₂ concentration during the sulfonation treatment can be from 1200 to 3000 ppm.

The concentration of solids in the fermentation medium can be about 9 to 14 percent prior to fermentation. The one or more organic acids can be selected from the group consisting of lactic acid, formic acid, propionic acid, fumaric acid, citric acid, butyric acid, gluconic acid, itaconic acid, pyruvic acid, salts thereof, and any combination of these organic acids or salts thereof.

The process may further comprises adding a feed component to the fermentation medium. The feed component may be an intermediate mill stream or an intermediate fermentation stream. The feed component may comprise an amino acid. The feed component may comprise lysine. The fermentation medium may be a corn mill stream. The process may further include a concentration or evaporation step. This step can increase concentration of solids in the feed ingredient or fermentation medium to about 45 to 65 wt percent.

The process further comprising combining the feed ingredient with a protein concentrate to form a feed product. The protein concentrate may comprise corn protein.

The process can include a drying step. The moisture content of the feed ingredient or feed product can be less than 9 percent after the drying step. The ANF reduction step may comprise a phytase treatment. The phytase treatment can increase the bioavailable phosphorus content of the feed product.

The fermentation medium can be fermented using a microorganism endogenous to the fermentation medium. The process can include the step of inoculating the fermentation medium with a microorganism. The fermentation medium can be sterilized or pasteurized prior to inoculating. The microorganism is of a genus selected from the group consisting of Lactobacillus, Leuconostoc, Acetobacter, Aspergillus, Bacillus, Brevibacterium, Clostridium, Corynebacterium, Micrococcus, Penicillium, Rhizopus, and Saccharomyces.

At any point after the fermentation step and any ANF reduction treatment step, a sulfonation step can take place, wherein the fermentation medium is treated with a source of bisulfite ions. A source of bisulfite ions (e.g., sodium bisulfite i.e., SBS) is added to the fermentation medium after fermentation in order to sulfonate mycotoxins and render the mycotoxins non-toxic. Thus, this sulfonation step reduces the amount of undesirable mycotoxins in the feed ingredient. In particular, the mycotoxin present in the raw materials can be DON, which is then sulfonated in the presence of a bisulfite ion source, e.g., SBS, to produce DON-S (sulfonated DON), which is considered non-toxic. This sulfonation is carried out at a pH that maintains the healthy bacterial count during the previous fermentation step.

The invention also covers a bisulfite-treated steeping water comprising:
one or more proteins and/or one or more sugars
less than 10 ppm of mycotoxins based on total weight of the feed ingredient,
at least 0.1 ppm of sulfonated mycotoxins and derivatives thereof based on total weight of the feed ingredient, and
optionally degradation compounds of the sulfonated mycotoxins.

Such a bisulfite-treated steeping water can be prepared with a process comprising the following steps:
providing a steeping water comprising one or more proteins and/or one or more sugars,
optionally adjusting the pH of the steeping water, and
treating the steeping water with a source of bisulfite ions to carry out a sulfonation treatment to reduce the amount of mycotoxins, and
optionally concentrating the steeping water.

### BRIEF DESCRIPTION OF THE DRAWINGS

The following detailed description of the invention will be better understood when read in conjunction with the appended drawings. It should be understood, however, that the invention is not limited to the precise arrangements and instrumentalities of the embodiments shown in the drawings.

FIG. 1 is a diagram of the prior art process according to WO17112841A1 for producing a feed ingredient, as well as the product, and diet.

FIG. 2 is a diagram of an exemplary embodiment of a process for producing a feed ingredient including the SBS treatment step, as well as the downstream process for producing the feed product, and the feed diet.

FIG. 3 is a diagram of an exemplary embodiment of a process for producing a feed ingredient including the SBS treatment step, as well as the downstream process for producing the feed product, and the feed diet, wherein the SBS treatment step takes place after concentration of the fermentation medium.

FIG. 4 is a diagram of an exemplary embodiment of a process for producing a feed ingredient including the SBS treatment step, as well as the downstream process for producing the feed product, and the feed diet, wherein the SBS treatment step takes place before concentration of the fermentation medium and also after, if deemed necessary.

FIG. 5 shows a graph relating to DON sulfonation reversibility with changes in temperature and pH over time. Temperature and pHs are reflective of anticipated processing condition (47° C., 4.1) and bovine ruminal temperature (39° C., 6.2)

FIG. 6 shows a graph relating to DON sulfonation reversibility with changes in temperature and pH. Temperature and pHs are reflective of anticipated processing condition (47° C., 4.1 for steeping, and 70° C., 4.1 for evaporation), bovine ruminal temperature (39° C., 6.2), and extended unanticipated holds (RT, pH 4 and pH 6.25). Room temperature (RT) is 21° C. in this case.

FIG. 7 shows the sulfites, sulfates, and free phosphates release in fermentation broths.

FIG. 8 shows DON levels and % reduction in fermentation broths post SBS addition.

FIG. 9 shows structures of three forms of DON and 10-DON-sulfonates.

FIG. 10 shows the types and concentrations of DON-S molecules recovered from the two standard solutions via LC-MS for Solution A.

FIG. 11 shows the types and concentrations of DON-S molecules recovered from the two standard solutions via LC-MS for Solution B.

FIG. 12 shows DON and various DON-S distributions in Motiv® ingredients (OA syrup, Motiv® syrup, and Motiv® product) across several production runs (R3, R5, R8, & R10).

FIG. 13 shows DON and Total DON-S distributions in Motiv® ingredients (OA syrup, Motiv® syrup, and Motiv® product) across several production runs (R3, R5, R8, & R10).

### DETAILED DESCRIPTION

It is to be understood that the figures and descriptions of the present invention provided herein have been simplified to illustrate elements that are relevant for a clear understanding of the present invention, while eliminating other elements found in the related field(s) of art. Those of ordinary skill in the art would recognize that other elements or steps may be desirable or required in implementing the present invention. However, because such elements or steps are well known in the art or do not facilitate a better understanding of the present invention, a discussion of such elements or steps is not provided herein.

Unless defined otherwise herein, all technical and scientific terms used herein have the same meaning as commonly understood by one of ordinary skill in the art to which this invention belongs. As used herein, each of the following terms has the meaning associated with it as defined in this section.

As used herein, the term “fermented vegetable protein” (FVP) refers to a mixture of protein and one or more fermentation products obtained via fermentation of a process stream associated with processing vegetable matter. In a preferred embodiment, the fermentation product is an organic acid. The process stream that is fermented can be any stream associated with a vegetable milling process. Other suitable process streams can include any waste or byproduct streams from vegetable processing. For the purposes of this disclosure, vegetable matter can include any materials associated with fruits, vegetables, grains, or other plants that are suitable for use as food for animals, or that can be converted into a material suitable for use as food for animals. Accordingly, other terms can be used herein to refer to a fermented vegetable protein, for example “fermented grain protein” or “fermented corn protein.” Further, the terms “feed ingredient,” “feed product,” and “feed diet” as used herein refer to compositions that include a fermented vegetable protein according to the present invention, unless otherwise noted.

Throughout this disclosure, various aspects of the invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 7 should be considered to have specifically disclosed subranges such as from 1 to 3, from 1 to 4, from 1 to 6, from 2 to 5, from 3 to 5, etc., as well as individual numbers within that range, for example, 1, 2, 3, 3.6, 4, 5, 5.8, 6, 7, and any whole and partial increments in between. This applies regardless of the breadth of the range.

All weight percentages are based on the total weight of the feed composition, ingredient, product or diet as appropriate, unless indicated otherwise.

### Animal Feed Compositions (Referred to Herein Also as “Feed Compositions”)

The present invention relates to feed compositions, such as feed ingredients, feed products, and feed diets including such ingredients and products. The feed ingredients and products are particularly useful in aquaculture applications, such as for feeding shrimp. However, the feed ingredients and products can be used for other animals, such as poultry and swine.

The feed composition includes:
at least one organic acid, for instance in the form of a mixture of its acid and conjugate base and/or salt,
optionally at least one protein,
optionally phosphorus,
optionally phytic acid,
less than 10 ppm, preferably less than 5 ppm, more preferably less than 2 ppm, yet more preferably less than 1.5 ppm, even more preferably less than 1 ppm and most preferably less than 0.5 ppm of mycotoxins, in particular DON, based on the total weight of the feed composition,
at least 0.1 ppm, or at least 0.5 ppm, or at least 1 ppm, or at least 1.5 ppm, or at least 2 ppm of sulfonated mycotoxins and derivatives thereof, in particular DON-S and derivatives thereof, based on the total weight of the feed composition, and
optionally degradation compounds of the sulfonated mycotoxins, in particular of DON-S.

Of note is that sulfonated mycotoxins and their degradation compounds are considered non-toxic, deactivated mycotoxins that are safe for use in feed ingredients, products and diets, in particular for use in aquaculture applications, such as for feeding shrimp.

The feed ingredient can include other nutrients or components, for example, but not limited to phosphates, peptides, free amino nitrogen (FAN), soluble proteins, soluble carbohydrates, vitamins, minerals, cofactors, and non-protein nitrogen. The feed product is a composition that includes the feed ingredient and other components, and that is typically manufactured to be a relatively homogenous and substantially dry material. The feed diet is a composition that includes the feed product and any other components that are needed to supplement or complete the dietary needs of an animal.

### Animal Feed Ingredients (Referred to Herein Also as “Feed Ingredients”

The feed ingredient of the present invention includes a fermented vegetable protein composition. The feed ingredient can be a fermented corn protein. However, vegetable matter other than corn can be used to make the feed ingredient, either instead of or in addition to corn protein.

The feed ingredient according to the invention has
at least one organic acid, for instance in the form of a mixture of its acid and conjugate base and/or salt,
at least one protein,
optionally phosphorus,
optionally phytic acid,
less than 10 ppm, preferably less than 5 ppm, more preferably less than 2 ppm, yet more preferably less than 1.5 ppm, even more preferably less than 1 ppm, and most preferably less than 0.5 ppm of mycotoxins, in particular DON, based on the total weight of the feed ingredient,
at least 0.1 ppm, or at least 0.5 ppm, or at least 1 ppm, or at least 1.5 ppm, or at least 2 ppm of sulfonated mycotoxins and derivatives thereof, in particular DON-S and derivatives thereof, based on the total weight of the feed ingredient, and
optionally degradation compounds of the sulfonated mycotoxins, in particular of DON-S.

The DON-S present in the feed ingredient are generally in the form of one or more of compound (a) “10-DON sulfonate”, compound (b) “8-DON sulfonate”, and derivatives thereof.

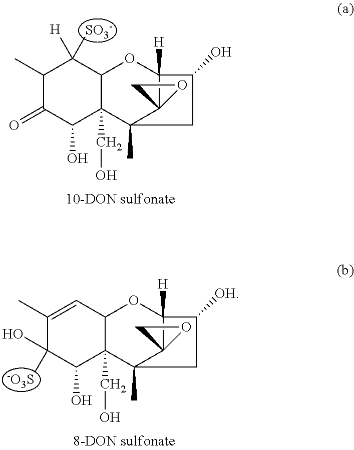

Literature confirms that the sulfonated DON (DON-S) species and derivatives no longer possess the toxic properties of the un-sulfonated mycotoxin substrate. The sulfonated mycotoxins and their degradation compounds are thus considered non-toxic/deactivated mycotoxins that are safe for use in feed ingredients for many animal species tolerant to higher sulfur loading. The sulfonated compounds thus do not need to be removed. The feed ingredient is in particular suitable for use in aquaculture feeds and diets, such as for feeding shrimp. The feed ingredient may also contain degradation compounds of DON-S, in particular selected from one or more of:

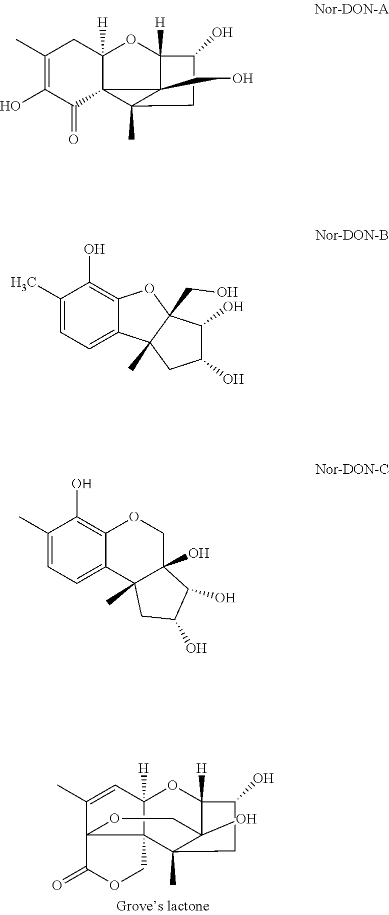

Other degradation compounds in the feed ingredient may also include one or more of the following compounds: Nor-DON-D, Nor-DON-E, Nor-DON-F, Nor-DON-G, and Nor-DON-H.

The organic acid of the feed ingredient can be lactic acid, in its lactate form, preferably a high quality, bioavailable source of lactic acid. The feed ingredient can include another organic acid instead of, or in addition to, lactic acid. Non-limiting examples of organic acids useful for the feed ingredients described herein include formic acid, citric acid, acetic acid, succinic acid, malic acid, fumaric acid, propionic acid, gluconic acid, itaconic acid, pyruvic acid, and butyric acid. As would be understood by a person skilled in the art, other organic acids not specifically listed herein can be used for the feed ingredients of the present invention. The feed ingredient can include a fermentation product other than an organic acid.

For instance, the one or more organic acids of the feed ingredient are organic acids that can be produced via fermentation and converted into their salt form, for example by caustic addition. As used herein, the term “organic acid” can refer to the acid in either its un-dissociated or dissociated form. Accordingly, the feed ingredient of the present invention can include an organic acid, the conjugate base of the organic acid, and/or a salt of the organic acid. The salt of the organic acid is preferably a sodium, potassium, or calcium salt or mixture thereof. The total organic acid content of the feed ingredient can be at least 45 percent dry basis (d.b.). The organic acid content of the feed ingredient can be in the range of about 35 to 60 percent, 40 to 55 percent, 45 to 50 percent d.b. The lactic acid content, or the content of another single organic acid, can be at least 38 percent d.b. The lactic acid content can be in the range of about 30 to 50 percent, 35 to 45 percent, or 38 to 43 percent d.b.

The feed ingredient also includes one or more proteins and/or components derived from proteins, such as free amino acids and low molecular weight peptides (e.g., peptides having a molecular weight less than 1000 Da).

The feed ingredient can be made by fermenting light steep water or some other stream associated with a corn milling process. Accordingly, the ingredient may include corn protein and/or has an amino acid profile that is consistent with corn protein, as would be understood by a person skilled in the art. The feed ingredient can have a protein content in the range of about 20 to 40 percent, 25 to 35 percent, or 28 to 31 percent dry basis. The feed ingredient may include a lysine content of about 2 to 5 percent or 2.5 to 3.5 percent d.b., which generally correlates to the lower lysine content typically found in corn protein. However, lysine can be added to increase the lysine content of the feed ingredient. For example, the lysine content of the feed ingredient can be in the range of about 10 to 15 percent or 11 to 13 percent d.b.

Other components can be added to and/or combined with the feed ingredient, instead of, or in addition to lysine. For example, components that would not typically be found in the fermentation medium or in the fermentation product can be added to improve the nutritional value of the feed ingredient. Further, as would be understood by a person skilled in the art, the addition of other components to the feed ingredient will result in a change of the overall protein and/or organic acid concentration of the feed ingredient. For example, a feed ingredient containing a higher lysine content of 11 to 13 percent can have a protein concentration of 37 to 39 percent, a total organic acid content of 39 to 42 percent, and a lactic acid content of 32 to 36 percent d.b.

The feed ingredient is preferably low in anti-nutritional factors (ANFs). For example, corn mill streams are known to include phytic acid. In one embodiment, phytase can be added during processing of the feed ingredient to hydrolyze phytic acid. Accordingly, the feed ingredient can be low in phytic acid, for example, having less than 1 percent, less than 0.6 percent, less than 0.5 percent, less than 0.4 percent, less than 0.3 percent, less than 0.2 percent, or less than 0.1 percent phytic acid on a dry basis.

Further, phytase treatment of a corn mill stream or a corn protein concentrate slurry can result in freeing phosphorous bound to the phytic acid ring. Therefore, the feed ingredient can include phosphorous, in free phosphate form, for example, having at least 0.5 percent, 1 percent, 1.5 percent, or 2 percent, 3 percent, 4 percent, 5 percent, 6 percent, or more, on d.b. The feed ingredient can contain 1 to 7 percent, 2 to 6 percent, or 4 to 6 percent free phosphate on a dry basis.

As described below, the feed ingredient can be produced through fermentation of any vegetable mill stream, for example the fermentation of light steep water. Accordingly, the feed ingredient can be in a liquid form, for example a liquid including 9 to 14 wt percent soluble and/or solid material on a dry basis. Producing the feed ingredient can include a concentration or evaporation step, which can result in a concentrated liquid or syrup, for example a syrup including 40 to 75 percent, more preferably 45-52 wt percent solids on a dry basis. In one embodiment, the feed ingredient is dried to reduce the moisture content to less than 10 wt percent.

### Animal Feed Products (Referred to Herein Also as “Feed Ingredients”)

The present invention also relates to feed products that include the feed ingredient described herein. In a preferred embodiment, the feed product includes other components in addition to the feed ingredient of the present invention. For example, the feed ingredient can be formulated with other feed ingredients or additives to change the amino acid profile, or to include other nutritional components. In one embodiment, the feed ingredient is blended or otherwise combined with other components prior to drying. In a preferred embodiment, the feed ingredient is blended and co-dried with other components to produce a relatively homogenous feed product. The feed ingredient can be blended and co-dried with a corn protein concentrate, e.g., Empyreal® corn protein concentrate. The feed product can be a powder, granule, pellet, or other dry form, as would be understood by a person skilled in the art, for example a dry material having less than 10, less than 9, less than 8, less than 7, less than 6, less than 5, less than 4, less than 3, less than 2, or less than 1 wt percent moisture.

The total organic acid content of the feed product can be greater than 8 percent dry basis. The total organic acid content of the feed product can be in the range of about 6 to 11 percent, 7 to 10 percent, 7.5 to 9.5 percent, or 8 to 9 percent d.b. The lactic acid content of the feed product can be in the range of about 5 to 9 percent, 6 to 8 percent, or 6.5 to 7.5 percent d.b.

The feed product can have a total protein content in the range of about 60 to 85 percent, 65 to 80 percent, 70 to 78 percent, 72 to 76 percent, or 73 to 75 percent dry basis. The lysine content of the feed product can be in the range of about 2 to 5 percent, 3 to 4 percent, or 3.1 to 3.6 percent d.b.

It is contemplated herein that the feed ingredients and feed products described herein can be processed such that the various components are combined to be a substantially homogenous material. The various components and materials of the feed ingredients or feed products of the present invention can be bound together with the fermented vegetable protein, and not just merely mixed together. Accordingly, as would be understood by a person skilled in the art, the fermented vegetable protein can be more advantageous for use as a feed due to this binding and homogeneity, as compared with currently available feed materials. In one aspect, the fermented vegetable protein containing feed product has:
less than 10 ppm, preferably less than 5 ppm, more preferably less than 2 ppm, yet more preferably less than 1.5 ppm, even more preferably less than 1 ppm, and most preferably less than 0.5 ppm of mycotoxins, in particular DON, based on the total weight of the feed ingredient, and
at least 0.1 ppm, or at least 0.5 ppm, or at least 1 ppm, or at least 1.5 ppm, or at least 2 ppm of sulfonated mycotoxins and derivatives thereof, in particular DON-S and derivatives thereof, based on the total weight of the feed ingredient, and
optionally degradation compounds of the sulfonated mycotoxins, in particular of DON-S.

### Animal Feed Diets (Referred to Herein Also as “Feed Diets”)

The present invention also relates to feed diets. The feed diets include the feed ingredients or feed products described herein in combination with one or more other feed ingredients or feed products. Such combinations can provide a complete and balanced diet for an animal. In one embodiment, the feed diet is a shrimp diet. The feed product may include about 2 to 24 wt percent of the feed product described herein.

Table 1 of WO17112841A1, which is incorporated herein by reference, shows the percent inclusion of various materials in selected shrimp diets. The amounts of various ingredients and components are shown for a reference diet, i.e., a currently available commercial feed diet, and exemplary feed diets of the present invention, i.e., feed diets that include 6 percent, 12 percent, or 20 percent FVP-FP. Fixed micro-ingredients are ingredients having identical amounts in each feed diet. The amounts of soybean meal and anchovy fishmeal in each diet are adjusted to account for increasing inclusion of FVP-FP.

Notably, the feed diets that include FVP-FP have higher protein and less ash than the reference diet but include less fishmeal. Fishmeal is one of the most expensive ingredients in shrimp feed diets.

### Animal Feed Manufacturing Methods

The present invention also relates to processes for making feed ingredients and feed products. The feed ingredients can be made by processing mill streams, for example by fermenting a mill soluble stream, such as light steep water (LSW) to yield a fermented vegetable protein. The feed products can be made by blending and/or co-drying the feed ingredients with other components.

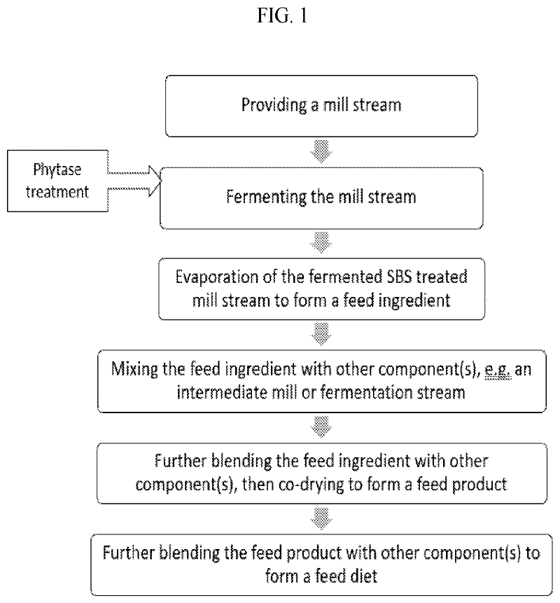

Referring now to FIG. 1, a diagram of a prior art process according to WO17112841A1 for making a feed ingredient, feed product, and/or a feed diet is shown. First, a mill stream such as LSW is provided as a fermentation medium. However, the mill stream can be any suitable fermentation medium containing a fermentable substrate, as would be understood by a person skilled in the art. In one aspect, the mill stream can also be a byproduct stream from a milling or fermentation process that includes a fermentable substrate. Examples of suitable mill streams, include, but are not limited to any wet stream from a process used to mill corn, wheat, sorghum, cassava, or any other grain, pulse, or vegetable material. An exemplary material useful as the fermentation medium in process is light steep water, which is high in protein and sugar, but also includes a significant amount of phytate. In other embodiments, materials such as gluten mill water (GMW) and filtrate streams from corn protein concentrate processing can be used. Slurries of dry grind streams are also suitable for process. It is contemplated herein that the mill stream includes a dissolved fermentation substrate, but the mill stream can include insoluble material instead of or in addition to the soluble material. Further, process can include one or more steps associated with preparing the mill stream for use as a fermentation medium, such as combining dry grind materials with water, diluting the mill stream provided, adding additional fermentation substrate, such as dextrose, to the mill stream, or performing an evaporation step on the mill stream provided.

Once the mill stream is provided, the mill stream can optionally be treated with phytase to hydrolyze phytic acid. The mill stream can be treated with other enzymes instead of, or in addition to, phytase. The mill stream is then fermented. The phytase treatment can be performed during or after fermentation step, instead of or in addition to a pre-fermentation treatment. The fermentation step increases the organic acid concentration of the mill stream. In one embodiment, the organic acid is lactic acid. In one embodiment, a base such as sodium hydroxide can optionally be added to convert some or all of the organic acid to a salt form. The mill stream and/or fermented mill stream can optionally be treated to reduce or eliminate one or more anti-nutritional factors other than phytic acid.

The fermentation conditions can be adjusted to optimize the rate of fermentation of the fermentation substrate to the desired fermentation product, for example lactic acid. In one embodiment, the temperature during the fermentation step can be held within a range that promotes a higher rate of formation for the desired product. For lactic acid as a fermentation product, the temperature range can be held in the range of about 47-55 degrees centigrade. Other conditions can also be adjusted, or other steps performed during fermentation to optimize the formation of the desired product. For example, in one embodiment, dextrose can be added during the fermentation, for example to perform a fed-batch type fermentation. In another embodiment, the pH can be adjusted during fermentation, for example by adding sodium hydroxide, lime slurry, or some other material. The pH during fermentation is maintained in the range of about 4.3 to 6.0.

The fermentation process is run for a predetermined amount of time, for example 40 to 50 hours. In other embodiments, the fermentation process can be run for more than 50 hours or less than 40 hours. As would be understood by a person skilled in the art, shorter fermentation process can result in unfermented sugars remaining in the feed ingredient. In other embodiments, the fermentation process can be run until most or all of the fermentation substrate is consumed, or until the formation of fermentation product has ceased. In one aspect, the preferred fermentation process conditions for fermenting light steep water are shown in Table 1. However, the fermentation process conditions are not limited to any specific values or ranges recited herein.

TABLE 1
Exemplary process conditions for a process for
producing a feed ingredient

| | Min | Max |
|---|---|---|
| 1. Time of fermentation (hrs) | 24 | 48 |
| 2. pH (averaged) | 4.3 | 5.5 |
| 3. Temperature (averaged, ºF) | 119 | 122 |
| 4. Phytase addition | 0.1% | |
| | on dry basis | |
| 5. Dextrose addition (g/L) | 24 | 55 |
| 6. Lactic Production (g/L/hr) | 0.5 | 4.0 |

In one embodiment, LSW is fermented. Light steep water is a byproduct of corn wet-milling that typically contains about 9 to 14 percent mill solubles or solids by weight. The solubles are generally sugars, proteins, small peptides, free amino acids, vitamins, and minerals, but can include other nutrients or compounds, as would be understood by a person skilled in the art. The fermentation step can be performed using naturally occurring microorganisms already present in the mill stream, for example lactobacilli bacteria typically found in LSW.

However, microorganisms other than naturally occurring lactobacilli bacteria can also be used, for example, a different type of bacteria, a yeast, or a fungus can be added to the fermentation process. In such a case, the mill stream can be pasteurized or sterilized prior to fermentation to reduce or eliminate any endogenous microorganisms. As would be understood by a person skilled in the art, the mill stream can then be adjusted to the desired fermentation temperature and inoculated with one or more microorganisms. Exemplary microorganisms include, but are not limited to: lactic acid bacteria, for example from homofermentative and heterofermentative Lactobacillus and Leuconostoc; Acetobacter; Aspergillus; Bacillus; Brevibacterium; Clostridium; Corynebacterium; Micrococcus; Penicillium; Rhizopus; and Saccharomyces and other yeasts.

Accordingly, the fermentation product can include a compound other than lactic acid, for example any other organic acid. A mixture of different bacteria, yeast, and/or fungi can be used, for example to provide a mixture of different fermentation products.

As described above, the process can include one or more steps directed to decreasing or eliminating one or more anti-nutritional factors. The process can include treatment with one or more enzymes. For example, the process can include a phytase treatment step, where an appropriate amount of phytase is used to release bound phosphorus from phytate, thereby creating a bioavailable phosphate form. The process can include a treatment step to reduce or eliminate the anti-nutrient sulfur dioxide, for example treating a mill stream with hydrogen peroxide.

However, there is no treatment included in FIG. 1, according to the prior art, to mitigate against the presence of mycotoxins, such as DON. The invention solves this mycotoxin challenge by introducing a sulfonation step described below.

### Sulfonation Treatment Step

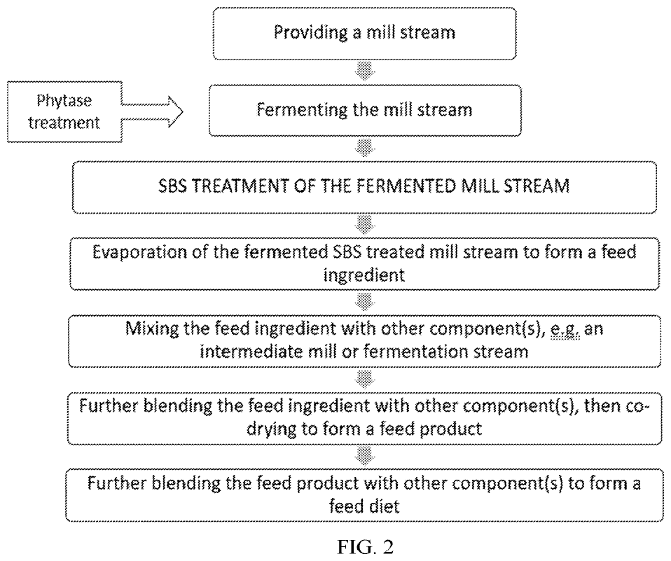

According to the invention, after fermentation and any optional treatment step to reduce ANF, the fermented mill stream can be treated with a source of bisulfite ions in order to reduce the amount of mycotoxins present (see FIG. 2). It was found that doing this sulfonation treatment after fermentation and any optional steps to reduce ANF was required in order to allow for healthy bacterial growth during the fermentation step and optimal enzymatic activity during any ANF reduction treatment step.

The source of bisulfite ions can be in the form of bisulfite salts, for instance sodium bisulfite (SBS), potassium bisulfite, calcium bisulfite, ammonium bisulfite or any combination thereof. Another alternative bisulfite source is CB427, a mixture of different bisulfite salts, available from Hydrite Chemical Company. Preferably, the source of bisulfite ions is SBS. In particular the SBS can be added as a solution of SBS, for instance at a 40 wt % solution.

The concentration of SO₂ in the medium during this treatment step is preferably from 1200 to 3000 ppm, more 1500 to 3000 ppm, most preferably from 1700 ppm to 2100 ppm, of SO₂.

Preferably, the sulfonation treatment step has a duration of 3 to 48 hours, preferably 6 to 24 hours, more preferably 12 to 20 hours, most preferably around 16 to 18 hours.

The duration of the sulfonation step depends on the bisulfite concentration. The higher the bisulfite concentration, the faster the reaction. However, a higher bisulfite concentration may also lead to a higher sulfur loading in the final feed ingredient, product and/or diet.

Preferably the pH of the fermentation medium during the sulfonation step was from 4.0 to 6.5, preferably 4.2 to 6.0, more preferably 4.5 to 5.5, most preferably 4.8 to 5.0, which is also the pH range for maintaining a healthy bacterial count, in particular during the previous fermentation step.

The duration of the sulfonation step also depends on the pH. A higher pH allows for a faster sulfonation reaction. However, starting from a higher pH is less than optimal for the previous fermentation step, wherein a healthy bacterial count is required, or for any prior ANF reduction treatment step, wherein optimal enzymatic activity is desirable. The pH may be increased after the fermentation/ANF reduction treatment step. However, increasing the pH requires additional treatment with a base, such as caustic, which may also lead to a higher sodium loading in the final feed ingredient, product and/or diet. Thus, carrying out the fermentation step, any ANF reduction treatment step and the sulfonation treatment at a pH of around 4.2 to 6.0, or 4.3 to 5.5, or 4.8 to 5.0 is preferred.

With this sulfonation treatment mycotoxin mitigation measure, it was possible to tolerate up to 2.4 ppm of DON in the incoming vegetable (e.g., corn) matter, so that the final feed ingredient had less than 10 ppm or less than 2 ppm DON.

### Concentration Step

The fermented mill stream can then be concentrated, for example by evaporation through applying heat and/or vacuum, to form a fermented vegetable protein (FVP) syrup, i.e., a feed ingredient. The FVP syrup is then blended with other components, for example an intermediate mill stream or an intermediate fermentation stream. In one embodiment, the component blended with the FVP syrup has a high lysine content. The blended syrup is then blended and co-dried with one or more other components, such as a high-protein corn gluten meal or corn protein concentrate (e.g., Empyreal® 75), to form a feed product. In one embodiment, the feed product of step can be further blended with, or added to, other feed ingredients or products to form a feed diet.

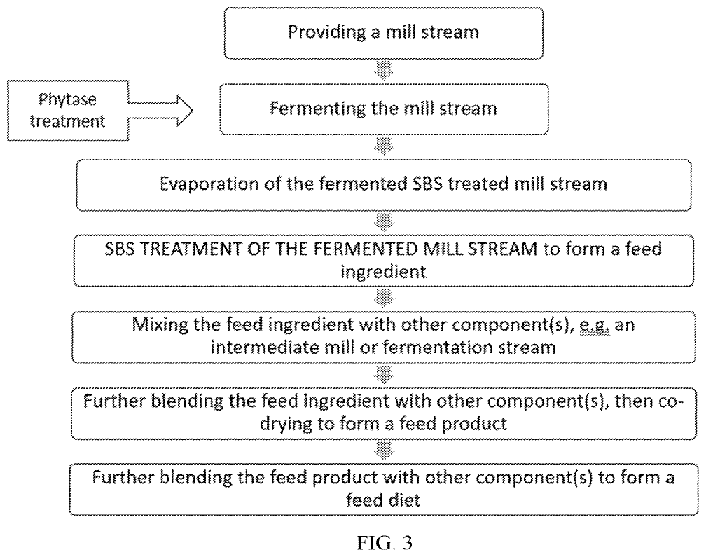

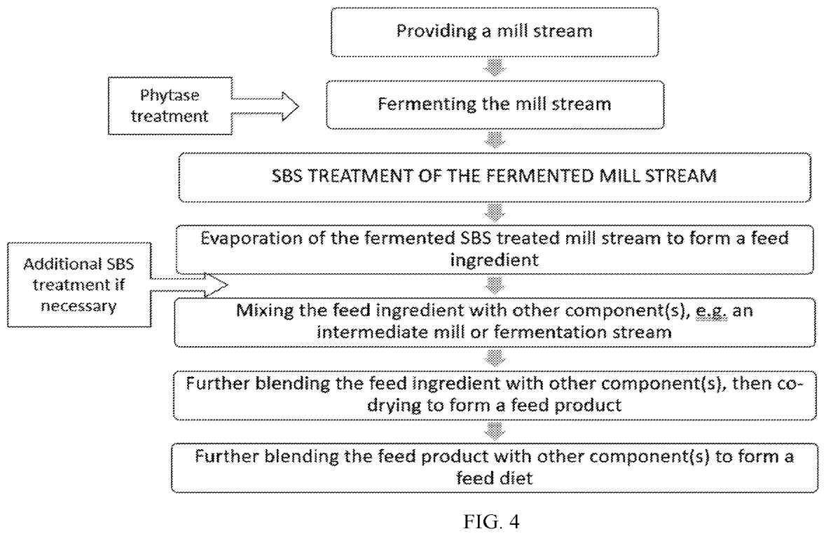

The process according to the present invention is not limited to the embodiments shown in FIG. 2. The process can include steps in a different order, or can utilize other materials, as would be understood by a person skilled in the art. For instance, it would also be feasible to carrying out the mycotoxin reduction i.e., sulfonation treatment step after the concentration step (see FIG. 3). Or it would also be feasible to carrying out the mycotoxin reduction step using the source of bisulfite ions both before and after the concentration step (see FIG. 4). Preferably, the mycotoxin reduction step takes place prior to concentration simply to provide a second opportunity after concentration to control the mycotoxin level again and carry out additional treatment with bisulfite ions if necessary (see FIG. 4).

The process includes a concentration step, which may involve evaporation. The evaporation is used to increase the concentration of dry solids. For example, in one embodiment, the weight percent dry solids of the process stream can be increased to about 40 to 75 percent solids, 45 to 65 percent solids, or 47 to 52 percent solids. The evaporation results in an FVP syrup that can be further processed as described below. The process may also include an evaporation prior to the fermentation step, instead of or in addition to the post-fermentation concentration. In such a case, the evaporation increases the soluble concentration of the process stream to about 40 wt. percent solids or greater on a dry basis prior to the fermentation step. For example, the fermentation step can be performed on corn steep liquor (CSL). CSL is also referred to as heavy steep water, and is generally formed by evaporating light steep water. As would be understood by a person skilled in the art, performing an evaporation on the mill stream prior to the fermentation step can result in the decrease or elimination of the native microorganism population. Accordingly, the concentrated mill stream after an evaporation may require inoculation with a suitable microorganism prior to fermentation.

(Co-)Drying and/or Blending Step(s)

The process can also include a drying step. The drying step can be performed at any point in the process after a fermented vegetable protein is formed. In one embodiment, the process stream can be co-dried with other streams to add other ingredients to the feed ingredient or product. For example, the process stream can be co-dried with a protein stream such as a corn protein isolate; a dewatered cake such as corn gluten meal; Empyreal (R) 75 corn protein concentrate; distillers solids; and/or any other suitable stream. Co-drying is particularly useful in the manufacturing process because it can improve the overall homogeneity of the feed ingredient or product in comparison to merely mixing additives into a dried FVP material.

The process can also include one or more blending or mixing steps. A blending step can be performed after drying the feed ingredient or product of the present invention, or it can be performed on any one of the wet process streams. As previously described, lysine can be blended with the FVP syrup feed ingredient. The FVP syrup feed ingredient can be blended and co-dried with a corn protein concentrate to form a feed product. Any suitable feed component can be combined with the FVP material. For example, any intermediate stream from a vegetable milling or fermentation process can be used as a feed component to be combined with the FVP material, including byproduct streams. In preferred embodiments, the feed components are combined with the FVP material prior to concentrating and/or drying the FVP material to improve the homogeneity of the feed ingredient or product.

An exemplary blending and co-drying process is described as follows: an FVP syrup having approximately 40 to 75 percent dry solids is applied to a second feed ingredient via an operation, for example spraying or another type of operation, to achieve relatively even distribution on the second ingredient. The second feed ingredient can be an FVP material according to the present invention, or it can be any other material suitable for feed. The FVP syrup can be applied at a predetermined rate, for example one to sixteen gallons per minute, via pump and nozzle to a liquid corn protein concentrate (5 to 20 percent DS) flowing at 200 to 400 gallons per minute. The two feed ingredient stream flow rates can be manipulated to achieve a desired application of FVP as a dry solids component of the final feed product, and to target specific levels of organic acid and/or amino acid levels in the feed product. The combined process stream can then be co-dried to achieve a desired moisture content of 2 to 8 percent. In one embodiment, the use of a flash drier with a temperature range of 200 to 270 degrees Fahrenheit for 8 to 12 minutes duration can achieve the desired moisture content. However, the blending and co-drying process steps of the present invention are not meant to be limited by the description above and can include any suitable operations, equipment, or conditions, as would be understood by a person skilled in the art.

### Method for Feeding Animals

Described herein are feed ingredients and products that can be used to feed animals. These provide a complete diet, or at least supplement a complete diet, for an animal. In addition, described herein are feed ingredients and products that can reduce the spread of early mortality syndrome (EMS) in farmed shrimp. Early mortality syndrome (EMS), also known as acute hepatopancreatic necrosis syndrome (AHPNS) is a disease affecting shrimp that is generally believed to be caused by a bacterial infection. EMS can quickly spread among farmed shrimp populations, causing mortality rates of up to 90 percent within 30 days. Therefore, the prevention or mitigation of the occurrence of EMS in shrimp farms is desirable.

Accordingly, the present invention further relates to a methods of feeding an animal. In one embodiment, the animal is a shrimp, but the method may be suitable for use in other animals.

The invention can also be described according to the following clauses:
Clause 1. A feed ingredient, comprising:
   one or more organic acids,
   one or more proteins,
   less than 10 ppm of mycotoxins based on total weight of the feed ingredient,
   at least 0.1 ppm of sulfonated mycotoxins and derivatives thereof based on total weight of the feed ingredient, and
   optionally degradation compounds of the sulfonated mycotoxins.
Clause 2. The feed ingredient according to clause 1, wherein the one or more proteins comprise or essentially consist of corn protein.
Clause 3. The feed ingredient according to clause 1 or 2, wherein the one or more proteins comprise or essentially consist of fermented corn protein.
Clause 4. The feed ingredient according to any one of the preceding clauses, wherein the mycotoxins are deoxynivalenol and the sulfonated mycotoxins are sulfonated deoxynivalenol.
Clause 5. The feed ingredient according to any one of the preceding clauses, wherein the feed ingredient has less than 5 ppm, or less than 2 ppm, preferably less than 1.5 ppm, preferably less than 1 ppm, more preferably less than 0.5 ppm of mycotoxin, in particular of DON, based on total weight of the feed ingredient.
Clause 6. The feed ingredient according to any one of the preceding clauses, wherein the feed ingredient has at least 0.2 ppm, or at least 0.5 ppm, or at least 1 ppm, or at least 2 ppm of sulfonated mycotoxins and derivatives thereof, in particular of DON-S and derivatives thereof, based on total weight of the feed ingredient.
Clause 7. The feed ingredient according to any one of the preceding clauses, wherein the feed ingredient has degradation compounds of the sulfonated mycotoxins, in particular of DON-S.
Clause 8. The feed ingredient according to any one of the preceding clauses, wherein DON-S comprise one or both of compounds (a) and (b):

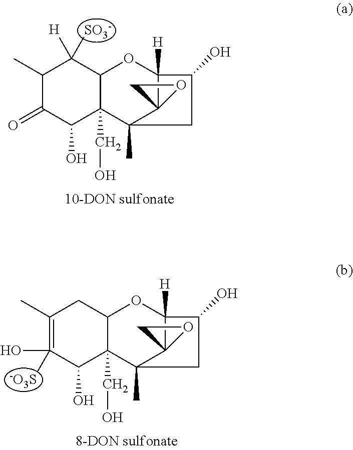

Clause 9. The feed ingredient according to any one of the preceding clauses wherein the degradation compounds of DON-S are selected from one or more of the following:

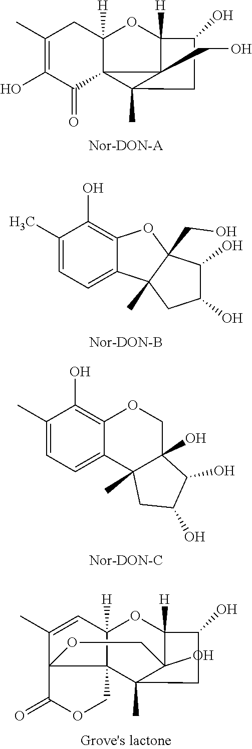

Clause 10. The feed ingredient according to any one of the preceding clauses, wherein the feed ingredient further comprises phosphorus and phytic acid.

Clause The feed ingredient according to any one of the preceding clauses, wherein the one or more organic acids are selected from the group consisting of lactic acid, formic acid, propionic acid, fumaric acid, citric acid, butyric acid, gluconic acid, itaconic acid, pyruvic acid, salts thereof, and any combination of these organic acids or salts thereof.
Clause 12. The feed ingredient according to any one of the preceding clauses, wherein the one or more organic acids are present in an amount suitable for reducing the gastric pH of an animal.
Clause 13. The feed ingredient according to any one of the preceding clauses, wherein the one or more organic acids are present in an amount of about 45 to 50 wt percent dry basis.
Clause 14. The feed ingredient according to any one of the preceding clauses, wherein the one or more proteins comprise corn protein.
Clause 15. The feed ingredient according to any one of the preceding clauses, wherein the one or more proteins are present in an amount of about 25 to 35 wt percent dry basis.
Clause 16. The feed ingredient according to any one of the preceding clauses, comprising 4.0 to 6.0 wt percent free phosphate on dry basis.
Clause 17. The feed ingredient according to any one of the preceding clauses, comprising 38 to 43 wt percent lactic acid on dry basis.
Clause 18. The feed ingredient according to any one of the preceding clauses, comprising less than 2 wt percent of sugars on dry basis.
Clause 19. The feed ingredient according to any one of the preceding clauses, wherein the feed ingredient is at least 40 percent dry solids.
Clause 20. The feed ingredient according to any one of clauses 1 to 18, wherein the feed ingredient has at most 10 wt percent water.
Clause 21. A feed product, comprising: a feed ingredient according to any one of the preceding clauses.
Clause 22. The feed product of clause 21, further comprising corn protein concentrate.
Clause 23. The feed product of any of clauses 21-22, further comprising corn gluten meal.
Clause 24. The feed product of any of clauses 21-23, wherein the phytic acid content is less than 0.6 wt percent dry basis.
Clause 25. The feed product of any of clauses 21-24, wherein the feed product has an organic acid content of about 8.0 to 9.0 wt percent dry basis.
Clause 26. The feed product of any of clauses 21-25, comprising 72 to 76 wt percent protein dry basis.
Clause 27. The feed product of any of clauses 21-26, comprising 3.0 to 3.6 wt percent lysine dry basis.
Clause 28. The feed product of any of clauses 21-27, comprising 6 to 8 wt percent lactic acid dry basis.
Clause 29. The feed product of any of clauses 21-28, comprising 4.0 to 6.0 wt percent free phosphate on dry basis.
Clause 30. The feed product of any of clauses 21-29, comprising less than 2 wt percent of sugars on dry basis.
Clause 31. The feed product of any of clauses 21-30, having a moisture content of less than 10 or 9 percent.
Clause 32. A feed diet, comprising the feed ingredient of any of clauses 1-20 or the feed product of any of clauses 21-31.
Clause 33. A feed diet, comprising 2 to 24 percent of the feed product of any of clauses 21-32.
Clause 34. The feed diet of clause 33, comprising 10 to 14 percent of the feed product of any of clauses 21-31.
Clause 35. The feed diet of any of clauses 32-34, further comprising a fat.
Clause 36. The feed ingredient, feed product, or feed diet of any one of clauses 1-35, wherein the feed ingredient, feed product or feed diet is suitable for feeding an aquatic animal.
Clause 37. The feed ingredient, product, or diet of clause 36, wherein the aquatic animal is a shrimp.
Clause 38. A process for producing a feed ingredient, preferably according to any one of clauses 1 to 20, comprising:
   providing a fermentation medium comprising one or more proteins and one or more sugars,
   fermenting the fermentation medium to produce one or more organic acids,
   optionally adjusting the pH of the fermentation medium during fermentation,
   optionally adjusting the temperature of the fermentation medium during fermentation,
   optionally treating the fermentation medium to reduce an anti-nutritional factor (ANF),
   treating the fermentation medium with a source of bisulfite ions to carry out a sulfonation treatment, and
   concentrating the fermentation medium,
   obtaining the feed ingredient
Clause 39. The process of clause 38, wherein the SO₂ concentration in the fermentation medium during the sulfonation treatment with a bisulfite ion source can be from 1200 to 3000 ppm.

Clause The process of clauses 38 or 39, wherein source of bisulfite ions is selected from sodium bisulfite, potassium bisulfite, calcium bisulfite, ammonium bisulfite or any combination thereof.
Clause 41. The process of any one of clauses 38-40, wherein the source of bisulfite ions is sodium bisulfite at a concentration of from 10 wt % to 44 wt %, preferably from 40 wt % to 42 wt % when added to the fermentation medium.
Clause 42. The process of any one of clauses 38-41, wherein the sulfonation treatment is carried out for a duration of 3 to 48 hours, preferably 6 to 24 hours, more preferably 12 to 20 hours, most preferably 16 to 18 hours.
Clause 43. The process any one of clauses 38-42, wherein the pH of the fermentation medium during the sulfonation treatment is from 4.0 to 6.5, preferably 4.2 to 6.0, more preferably 4.5 to 5.5, most preferably 4.8 to 5.0.
Clause 44. The process any one of clauses 38-43, wherein the concentration of solids in the fermentation medium is about 9 to 17 percent prior to fermentation and/or wherein the concentration of solids in the concentrated fermentation medium is about 40 to 60 percent post evaporation.
Clause 45. The process of clause 44, wherein the concentration of solids in the fermentation medium is about 9 to 14 percent prior to fermentation.

Clause The process of any of clauses 38-45, wherein the fermentation medium is a corn mill stream.
Clause 47. The process of any of clauses 38-46, wherein the one or more organic acids are selected from the group consisting of lactic acid, formic acid, propionic acid, fumaric acid, citric acid, butyric acid, gluconic acid, itaconic acid, pyruvic acid, salts thereof, and any combination of these organic acids or salts thereof.
Clause 48. The process of any of clauses 38-47, further comprising adding a feed component to the fermentation medium.
Clause 49. The process of any of clauses 38-48, wherein the feed component is an intermediate mill stream or an intermediate fermentation stream.
Clause 50. The process of any of clauses 38-49, wherein the feed component comprises an amino acid.
Clause 51. The process of any of clauses 38-50, wherein the feed component comprises lysine.
Clause 52. The process of any of clauses 38-51, wherein concentrating the fermentation medium comprises an evaporation step.
Clause 53. The process of clause 52, wherein the evaporation step increases the concentration of solids in the feed ingredient or fermentation medium to about 40 to 60 wt percent.
Clause 54. The process of any of clauses 38-53, further comprising combining the feed ingredient with a protein concentrate to form a feed product.
Clause 55. The process of clause 54, wherein the protein concentrate comprises corn protein.
Clause 56. The process of any of clauses 38-55, further comprising a drying step.

Clause The process of clause 56, wherein the moisture content of the feed ingredient or feed product is less than 9 percent after the drying step.
Clause 58. The process of any of clauses 38-57, wherein the ANF reduction step comprises a phytase treatment.
Clause 59. The process clause 58, wherein the phytase treatment increases the bioavailable phosphorus content of the feed product.
Clause 60. The process of any of clauses 38-59, wherein the fermentation medium is fermented using a microorganism endogenous to the fermentation medium.
Clause 61. The process of any of clauses 38-60, further comprising inoculating the fermentation medium with a microorganism.
Clause 62. The process of clause 61, wherein the fermentation medium is sterilized or pasteurized prior to inoculating.
Clause 63. The process of clause 61 or 62, wherein the microorganism is of a genus selected from the group consisting of Lactobacillus, Leuconostoc, Acetobacter, Aspergillus, Bacillus, Brevibacterium, Clostridium, Corynebacterium, Micrococcus, Penicillium, Rhizopus, and Saccharomyces.
Clause 64. The process of any of clauses 38-63, wherein the feed ingredient or feed product is the feed ingredient or feed product of any of clauses 1-31.
Clause 65. A feed ingredient or feed product obtained from the process of any one of clauses 38 to 64.
Clause 66. A method for feeding an animal comprising administering the feed ingredient, feed product, or feed diet of any of clauses 1-37.
Clause 67. The method of clause 66, wherein the animal is a shrimp.
Clause 68. Use of a bisulfite ion source to sulfonate mycotoxins in a fermented feed composition.
Clause 69. The use according to clause 68, wherein the fermented feed composition is a vegetable protein composition.
Clause 70. The use according to clause 69, wherein the vegetable protein composition is a corn protein composition.
Clause 71. The use according to clause 70, wherein the corn protein composition comprises at least 50 wt % of corn protein on a dry basis.
Clause 72. A bisulfite-treated steeping water comprising:
   one or more proteins and/or one or more sugars,
   less than 10 ppm of mycotoxins based on total weight of the feed ingredient,
   at least 0.1 ppm of sulfonated mycotoxins and derivatives thereof based on total weight of the feed ingredient, and
   optionally degradation compounds of the sulfonated mycotoxins.
Clause 73. A process for producing the steeping-water referred to in clause 72 comprising:
   providing a steeping water comprising one or more proteins and/or one or more sugars,
   optionally adjusting the pH of the steeping water, and
   treating the steeping water with a source of bisulfite ions to carry out a sulfonation treatment to reduce the amount of mycotoxins, and
   optionally concentrating the steeping water.

### EXPERIMENTAL EXAMPLES

The disclosures of each and every patent, patent application, or publication cited herein are hereby incorporated by reference in their entirety. While this invention has been disclosed with reference to specific embodiments, other embodiments and variations of this invention may be devised by others skilled in the art without departing from the true spirit and scope of the invention. The appended claims are intended to be construed to include all such embodiments and variations.

### Example 1: Including a Sulfonation Treatment Step with Either SBS or CB427

Heavy steepwater, with appreciable levels of DON (can be up to 25 ppm) from processing incoming corn, was obtained from retains at a Cargill corn wet mill. This material was diluted to 12% dry solids (DS) prior to work to create the light steepwater. This light steepwater was prepared fresh for each set of experiments conducted.

Based on the sulfur content in the CB427 product available from Hydrite Chemical Company (as shown on their technical data sheet), a saturated sodium bisulfite (SBS) solution was prepared at an equivalent sulfur content for comparison to CB427.

Light steepwater was pH adjusted with 40% NaOH or 37% HCl to reach the desired test pH. Increasing pH caused phytate precipitation, and the precipitated phytate was allowed to remain in the light steepwater. The light steepwater was then autoclaved under standard conditions (121° C., 15 psi, and 15 minutes) to prevent unwanted microbial growth during the experimentation. Background work investigated the effect of autoclaving on DON concentration to understand if there was any thermal degradation of DON during autoclaving in the presence of copious amounts of water. No loss of DON was seen in light steepwater after autoclaving.

Light steepwater was then placed in sterile containers and aseptically dosed, based on total inclusion, with CB427 and/or 40% sodium bisulfite (SBS). For instance, a 1% dose of CB427 is 1 mL CB427 in 99 mL of light steepwater. When utilizing SBS solution, the dosing was 1.1× the CB427 dose to get equivalent sulfur dosing into the light steepwater (i.e., 1% dose of CB427 would be compared to 1.1% dose of 40% SBS). Samples were held at 70° C., 47° C., 39° C. and/or 22° C. for up to 2 days, with monitoring throughout the hold. Samples labelled control were dosed with water.

DON analysis was performed via an ELISA assay from Neogen (Veratox DON 2/3), which has been validated for work with corn steep as a sample matrix. The assay was conducted as described in the assay procedure form the manufacturer with the modification of omitting the methanol extraction procedure, as the sample was already a solution rather than a solid. Instead, light steepwater samples were pH adjusted with 40% NaOH to a range of pH 6 to 8, diluted with water, and thoroughly mixed to allow the DON level to be within linear range of the assay (0.5 to 6 ppm). Samples were then filtered through a Minisart RC-15 (0.45 μm) syringe filter. The remainder of the assay was performed in accordance to manufacturer's instructions. All samples were diluted once, and this dilution was analysed in duplicate on the test strip. All ELISA strips were run with the calibration samples on each strip to ensure the best possible quantitation. For calculation purposes, the assay strip reader assumes a 10× dilution/extraction occurs for all samples. Therefore, when calculating results back to the light steepwater, on an as is basis, all results from the strip reader need to be divided by 10, multiplied by the actual dilution utilized, and adjust for the additional volume from the 40% NaOH addition to get accurate quantitation.

### Results

The dose and time effect of sulfur solutions on DON content in light steepwater when held at pH 6.25 and 39° C. for up to 24 hours are shown in Table 2. The values are expressed as a percent reduction of DON content from the control.

TABLE 2

| | Time (hrs) | | | |
|---|---|---|---|---|
| % Reduction | 1 | 3 | 6 | 24 |
| 1.1% SBS | 62.1% | 85.1% | 85.9% | 88.7% |
| 1% CB427 | 55.2% | 82.4% | 85.4% | 86.7% |
| 0.75% CB427 | 43.7% | 71.6% | 83.9% | 85.9% |
| 0.5% CB427 | 34.5% | 52.7% | 76.1% | 80.2% |
| 0.25% CB427 | 28.7% | 24.3% | 46.3% | 51.5% |
| 0.1% CB427 | 14.9% | 10.8% | 22.0% | 17.2% |

### CONCLUSION

When light steepwater, with a natural contamination of DON at 2.2 ppm, is treated with CB427 or saturated SBS solution at pH 6.25 and 39° C., DON content can be reduced by >80% within 3 hours (Table 2) by the formation of DON sulfonate (DON-S). The DON-S, without being bound by theory (see Schwartz, H E, et al. (2013), J. Agric. Food Chem. 61, 8941-8948), can be, for instance:

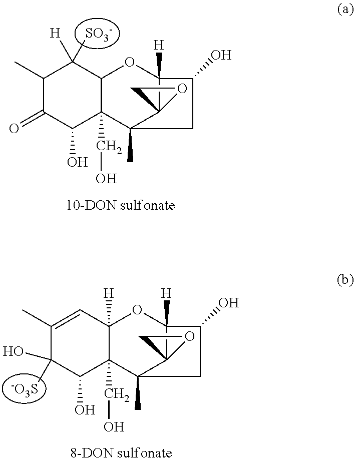

or derivatives of DON-S.

The amounts of 10-DON-S (a), 8-DON-S (b), and any other derivatives can be measured using the published procedure of Schwartz et al. (J. Agric. Food Chem. 2013, 61, 8941-8948):

1 g of Motiv product sample (or OA syrup or Motiv syrup) is extracted twice with 10 ml of methanol/water/formic acid (50:49:1, v/v/v) by mixing for 30 min. The combined liquids is centrifuged at 14,000×g prior to the UPLC-HRMS analysis. The UPLC-HRMS/MS analyses is carried out using the following experimental tools/steps:
An Agilent C18 column (150×2.1 mm, 1.8 μm) at a flow rate of 0.25 ml/min at 20C.
A gradient elution with two solvent system (water/formic acid (99.9:0.1, v/v) and methanol/formic acid (99.9:0.1, v/v)) as mobile phase.
A dual electrospray ion source (ESI) is utilized in negative mode.
A MS detector to record fragmentation patterns of DON, DON-S, and derivatives in MS/MS mode.

Based on SO₂ analysis of CB427, it was found that it contained an equivalent amount of sulfur as a 44.3% (w/w) solution of SBS. As SBS is only soluble to 42% in water, a 40% SBS solution was utilized for comparison, and a factor of 1.1 was used to get an equivalent dosing of SBS solution for comparison to CB427 (i.e. 1% dose of CB427 would be compared to 1.1% dose of 40% SBS). After 1, 3, 6, and 24 hours of treatment, there is little difference between equivalent dosing od CB427 and a saturated solution of SBS. Further testing utilized CB427 solution only, but the subsequent results are expected to be applicable to a situation in which a 40% SBS solution was substituted for CB427. The finding of equivalence at a 1% dose between CB427 and SBS indicates that the chemistry involved is basic sulfur chemistry, and any additional components of CB427 beyond various salts of bisulfite and sulfurous acid do not mediate additional sulfonation and removal of DON.

As dose is decreased from 1%, DON reduction is slowed, with 0.5% CB427 needing 24 hours to show an 80% DON reduction rather than 3 hours with a 1% dose. A 0.25% dose was only able to effect a 50% reduction of DON by 24 hours, and a 0.1% dose was only able to remove 20% of the DON present.

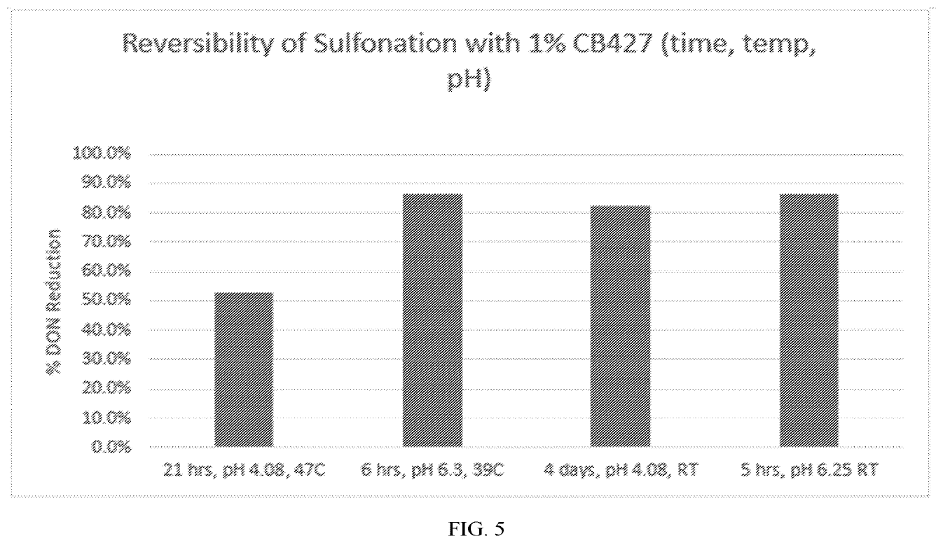

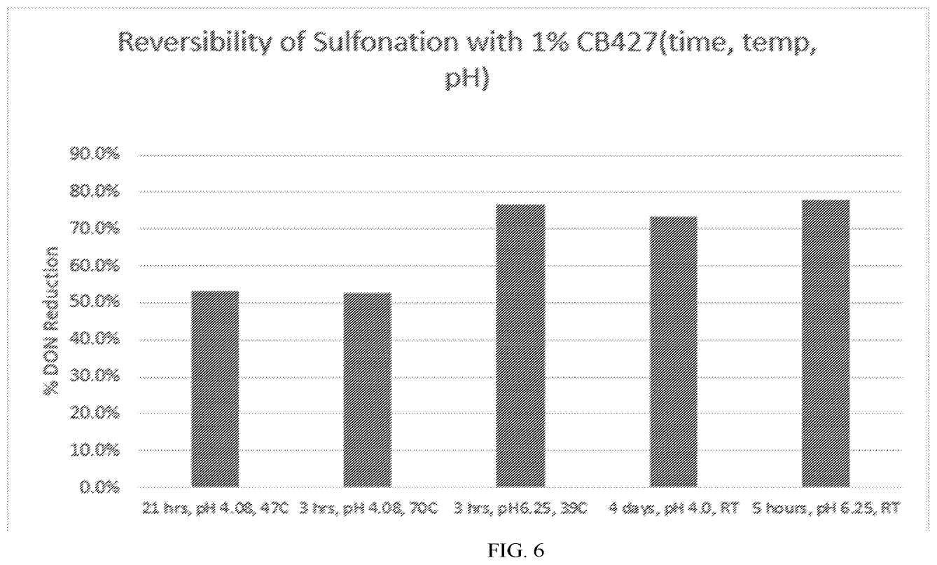

Once the DON-S is formed, reversal of the reaction to reform free DON is not observed under the typical mill conditions studied of pH 4.1 and 47° C. (FIG. 5). Under these condition, 50% of the DON is removed from the light steepwater in 21 hours. When the pH is raised to 6.2 (typical bovine ruminal pH), further reduction of DON is apparent (80% total reduction), and cycling the pH back and forth between 4.1 and 6.25 does not show any appreciable reformation of free DON over the course of an additional 4 days of storage at pH 4.1 and room temperature. A 4% drop in DON reduction was noted, but this value may well be within the variability of the ELISA assay at these ppm concentrations. Even under more harsh conditions, 70° C. and pH 4.1 to mimic elevated temperatures to be found in evaporation, no appreciable reformation of free DON over the course of 4 days is noted once DON-S is initially formed (FIG. 6). Again, only a 4% drop in DON reduction was seen when cycling between pH 6.25 and pH 4.1, and holding at 4.1 for 4 additional days.

Both of the tests summarized in FIGS. 5 and 6 showed much slower kinetics of DON reduction than was noted in Table 1 during the initial 21 hours of hold. When held at pH 6.25, >50% DON reduction is seen by 1 hour of treatment time, while at pH 4.1, this same reduction takes between 6 and 24 hours. This alteration in DON-S formation kinetics is due to the change in pH from 6.25 to 4.1, with the sulfonate formation being much slower at pH 4.1. Unfortunately, the native pH for light steepwater is 4.1, rather than the 6.25 which is expected to be found in the bovine rumen once the feed is ingested. This finding lends credence to the hypothesis that the formation of DON-S via sulfonation is mediated by SO₃²⁻, as this species is not present at pH 4.1, but its mole fraction of sulfur species is ~20% at pH 6.25 (as described by Birkmann, Jan & Pasel, C. & Luckas, Michael & Bathen, Dieter. (2019) and Development of a Measuring Method for the Determination of Bisulfite and Sulfite in Seawater. Chemie Ingenieur Technik, 10.1002/cite.201900004). Additional work with lower CB427 dosing at pH 4.1 confirmed this finding (FIG. 4). Lengthening the hold from 24 to 48 hours provides for only minimal improvement of DON reduction for the 1% CB427 dose, which increases from 51% to 55% reduction. Larger increases in additional DON removal between 24 and 48 hours are seen when CB427 is dosed at 0.75% and 0.5%. After 48 hours at pH 4.1, a 0.75% dose of CB427 leads to a 39% reduction in DON, while 0.5% leads to only a 23% reduction.

If a DON mitigation strategy involving sulfonation of DON to DON-S were to be employed, additional sulfur loading in the feed formulation will be a concern. To gain a 55% DON reduction at pH 4.1, which would be the pH at which CB427 or similar solution would be dosed for this purpose, a 1% dose of CB427 would be required with a concomitant increase in sulfur of 0.3% in the final feed formulation (as is basis). If the dose was decreased to 0.5%, only 23% of the DON could be removed, with a resultant increase of sulfur by 0.13% (as is basis). Species, such as swine and or poultry, could potentially handle this additional sulfur loading in a final feed product, such as Cargill's SweetBran®.

### Example 2: Manufacture of Motiv® with Reduced DON Using Sulfonation Chemistry

Manufacture of Motiv® with reduced DON using sulfonation chemistry.

### 1. Creation of Motiv® Fermentate:

Fresh raw light steep water (LSW) were added to a fermentation vessel with a target production of 60 g/L of lactic acid. Ingredients such as 95 refined liquid dextrose (RLD) and caustic (at 19% concentration) were supplemented to maintain pH at 5.0 and allow sufficient lactobacillus growth. Upon completion of the fermentation, phytase was added to reduce phytic acid and increase phosphorus bioavailability, making what is termed an Organic Acid (OA) broth. In a typical Motiv® run, fermented OA broth is then evaporated to make an OA syrup and supplemented with additional fermented lysine product to manufacture the final Motiv® Syrup.

### 2. Sodium Bisulfite (SBS) Addition to Post-Fermented Broth to Reduce DON:

To reduced DON in the final Motiv® product, sulfonation treatment was implemented in the Motiv® process (introduced into the process post-phytase treatment and prior to evaporation) to mitigate DON mycotoxins. In brief, a 40% SBS solution was added to the OA fermentation broth in the fermentation vessel at up to a 1.75% dry basis level and allowed to react for up to 24 hours prior to OA evaporation.

### 3. Motiv® Syrup Co-Drying:

In this last step of Motiv® production, corn protein concentrate wet cake is mixed with Motiv syrup to reach achieve the desired end product specifications of a final lactic acid content greater than 6.2%. Details of final DON mitigation using adequate blending ratios and sulfonation chemistry are found in Table 5.

TABLE 5
Additional details of final Motiv ® production run to
achieve a feed product within DON specification.

| Treatment | | Untreated | | | 1.75% | De- |
|---|---|---|---|---|---|---|
| Options: | | | | 2.4 ppm in | SBS at | sired |
| DON, ppm | Low | Inspec | | Dayton corn | pH 5.0 | levels |
| Corn | 0.33 | 0.75 | 1.00 | 2.40 | | <1 ppm |
| | | | | | | spec |
| LSW | 0.73 | 1.65 | 2.20 | 5.27 | | |
| HSW | 2.40 | 5.45 | 7.27 | 17.45 | | |
| OA broth | 0.65 | 1.47 | 1.96 | 4.69 | 0.30 | |
| OA syrup | 1.82 | 4.14 | 5.52 | 13.25 | 0.85 | |
| Motiv | 1.56 | 3.55 | 4.73 | 11.36 | 0.73 | |
| Syrup | | | | | | |
| Motiv | 0.74 | 1.50 | 1.95 | 4.46 | 0.42 | Blair codry |
| Product | | | | | | <2 ppm |
| | | | | | | spec |
| | 0.85 | 1.93 | 2.38 | 5.92 | 1.88 | Dayt codry |
| | | | | | | <2 ppm |
| | | | | | | spec |

### 4. Motiv® Analysis

Fermentation samples were tested for dry solids (60° C. oven method), anions, SO₃, SO₄, and PO₄ (by IC). Additional samples were taken at various timepoints throughout the SBS treatment, frozen if necessary, and tested for DON once thawed, again if necessary, via the HPLC/UV method.

### 5. Results of Phytase Addition and DON Mitigation SBS Treatments

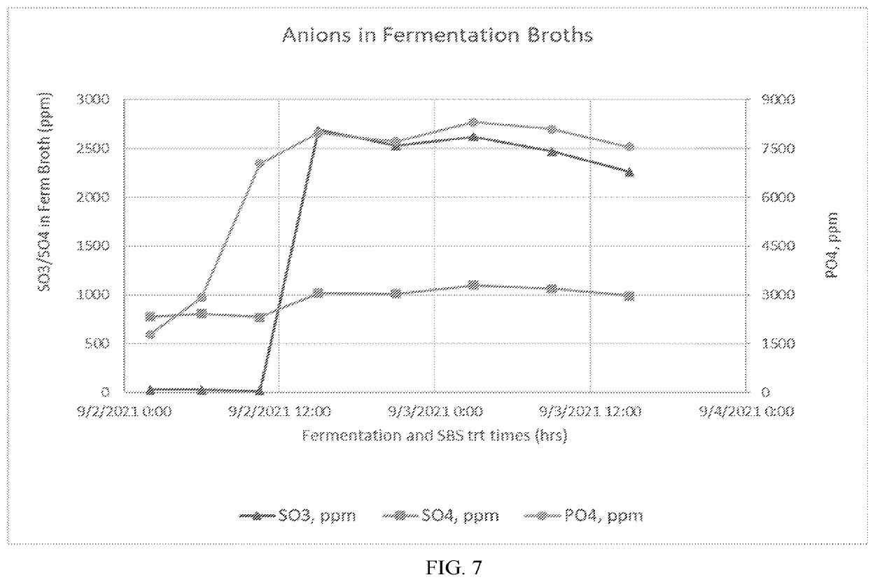

The anions (sulfites, sulfates, and free phosphates) were tracked in fermentation broth prior to and after both phytase and SBS addition to ensure the adequate hydrolysis of phytate molecule, as well as to monitor the abundant SO₂ present to sulfonate DON molecules (FIG. 7). Upon phytase addition, free phosphates increased from 1500 ppm to almost 8000 ppm, indicating a hydrolysis of phytate molecule. Similarly, a steep increase in SO₃²⁻ was detected upon the addition of SBS to the fermentation broth.

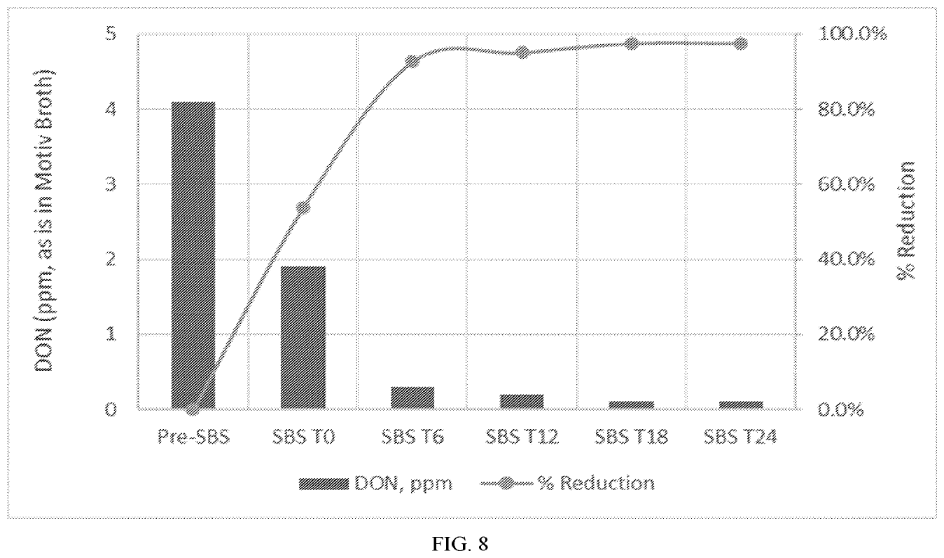

Following a similar trend to what has been found in several bench and plant trials, the SBS treatment worked extremely well, exhibiting a ~95% reduction to comfortably put the final MOTIV® projected DON levels in a great position to advance into the co-drying step. The DON level was reduced from 4 ppm to less than 0.2 ppm in the fermentation broths post the 24 hr incubation period (FIG. 8) and to 1.0 and 0.9 ppm in the final OA and Motiv® syrups, respectively.

### 6. Analysis of 10-DON-S (a), 8-DON-S (b), and Other Modified DON-S (Prophetic)

The amounts of 10-DON-S (a), 8-DON-S (b), and any other chemically modified DON-S, can be measured following the published procedure of Schwartz et al. as described above for Example 1.

### 7. Conclusions for Example 2

DON is regularly an issue in corn-based raw material for Motiv® production. SBS addition represents a solution for DON reduction to meet product specifications and regulatory requirements. The SBS was found to not have an adverse impact on the final product quality. Sodium bisulfite (SBS) addition, 1% dry basis dosing into light steep water, enabled a DON reduction in trials at both lab and plant scales with fermentation broths, HSW (heavy steep water), and OA syrups. SBS was added at the end of fermentation, and post phytase treatment, in order to eliminate any negative impact SBS may have on the fermentation and enzymatic treatment steps.

### Example 3: Measuring DON-Sulphonates in Motiv® Via LC-MS

This example describes the analysis of the presence of elevated deoxynivalenol (DON) in feed products such as E75 and Motiv that have specifications for DON of <2 ppm. Elevated DON in steep streams was identified as the most significant issue driving the organic acid syrup (OA syrup) and MOTIV syrup DON concentrations to extremely high levels (on the order of 15-20 ppm prior to the co-drying).

Samples of OA syrups, Motiv syrups, and Motiv were tested via LC-MS for sulfonated DON contents, and four types of 10-DON-S were detected (DON-S1, DON-S2, DON-S3a, & DON-S3b) post the SBS treatment process. The second type of 10-DON-S (DON-S2) was the most predominant among all four in the three ingredients analyzed herein. Final Motiv products revealed levels of 1.5-3.6 ppm of total sulfonated DON while maintaining the final DON level below the 2 ppm specification level.

DON and DON sulfonates were quantified in standard solutions, Motiv® final products, and Motiv ingredients (OA syrups and Motiv syrups) via LC-MS.

The objectives of this Example were to show that DON is converted into DON-S molecules or other degradation compounds in Motiv product/streams, and in particular quantitation of DON—S types was focused on. Further objectives include a closure of mass balance between DON reduction and formation of DON—S types in these reactions was investigated.

Procedure and Sample Collection: The work was conducted in three separate phases (production of DON Sulfonate standards, collection of Motiv ingredients from production semiworks, and analysis of DON/DON-Sulfonate solutions and Motiv Samples via LC-MS).

Production of DON Sulfonates: Aliquots of 1 mg of DON were dissolved in 2.0 mL of water containing 10% sodium sulfite (w/v) to form DON-S standard solution A or 2.0 mL of phosphate buffer (pH 6.5) containing 15% sodium metabisulfite (w/v) to form DON-S standard solution B. In both cases, solutions were shaken at 37° C. after 24 h and measured by Ultra High Pressure Liquid Chromatography High Resolution Accurate Mass spectrometry (UHPLC-HRAM) after dilution (or as needed to develop a calibration curve). Formulas for solution A and solution B can be found in Table 6.

TABLE 6
Amounts of chemicals used in the preparation
of DON-S standards:

| DON-S | DON-S | |
|---|---|---|
| Solution A | Type(s) | 1 & 2 |
| | Scale | Small |
| | | 1.0 mg of DON |
| | | 0.2 g of Na₂SO₃ |
| | | 2.0 mL of water |
| | Final Conc. | 500 mg/L or ppm |
| DON-S | DON-S | |
| Solution B | Type(s) | 3 |
| | Scale | Small |
| | | 1.0 mg of DON |
| | | 0.3 g of Na₂SO₃ |
| | | 2.0 mL of PO₄ buffer (pH 6.5) |
| | Final Conc. | 500 mg/L or ppm |

Approximately 2 mL of each sample was injected via a syringe into a 5-mL gas-tight glass vial (purchased from Millipore and sealed with 1 mg of DON solid) to ensure stability of the solutions and keep hazardous solutions contained. Aliquots of DON-S solutions were transferred via a syringe for LC-MS testing.

Product and Ingredients: Samples of OA syrup (48% DS), Motiv® syrup (49% DS), and Motiv® final products were used in the testing and quantification of DON and DON-S in Motiv® processes. In this case, Motiv® product and ingredients (originally contaminated or SBS-treated) from different semiworks runs, R3, R5, R8, & R10 were selected. In each Motiv® production run (R), approximately 20,000+Gal of OA syrup, 25,000+Gal of Motiv® syrup, and 200+MT (2+ railcars) of Motiv® product were manufactured. In most cases, the OA syrup was treated with either 1 or 2 totes of SBS (40% concentration, 250 Gal in every tote) for 24 hrs before converting the syrup into Motiv® syrup. The samples are summarized in Table 7.

TABLE 7
Motiv® product and ingredients (originally contaminated
or SBS-treated) from different semiworks runs, R3, R5,
R8, & R10, with their corresponding expected ppm
levels prior to LC-MS testing):

| | | DON and | Expected | |
|---|---|---|---|---|
| Sample Type & | | DON-S | DON Conc. | |
| Treatment | | presence | (pre-testing) | |
| OA Syrup-1 | R3, No SBS | Intact DON | ~15 | ppm |
| OA Syrup-2 | R5, No SBS | molecule | ~15 | ppm |
| OA Syrup | R5, + | | <2 | ppm |
| Motiv Syrup | SBS | Might have | <2 | ppm |
| Motiv | R8, + | >2 ppm of | <2 | ppm |
| OA Syrup | SBS | sulfonated | <2 | ppm |
| Motiv Syrup | | DON, but | <2 | ppm |
| Motiv | | <2 ppm of | <2 | ppm |
| OA Syrup | R10, + | intact DON | <2 | ppm |
| Motiv Syrup | SBS | | <2 | ppm |
| Motiv | | | <2 | ppm |

LC-MS Analysis: Analyzing DON sulfonate solutions and Motiv samples on were analyzed by LC-MS. Briefly, 200 mg of Motiv product samples (or OA & Motiv syrups), with appropriate dilutions of ~1:20 for the syrups and final products, were extracted in duplicate with 5 mL each of methanol:water: formic acid (20:80:0.1, v/v/v) by rotation mixing (30 rpm) for 30 min. The extracted liquids were centrifuged at 14,000×g prior to UHPLC-HESI-HRAM analysis. The UHPLC-MS analyses were carried out using the following:
i) an ACE Octadecyl-Penta Fluoro Phenyl (C18-PFP) column (150×2.1 mm, 2 μm) at a flow rate of 0.3 mL/min at 25C;
ii) a gradient elution with a two solvent system (water: formic acid (99.9:0.1, v/v) and methanol as mobile phases;
iii) a heated electrospray ion source (HESI) in negative mode; and
iv) a HRAM detector at 70,000 mass resolution in full scan mode (100 to 1000 m/z).

A series of dilutions on DON, DON-S A, DON-S B standard solutions was performed (10 to 0.01 ppm level) and evaluated on LC-MS. A regression plot (measured vs. original concentrations) was acquired. Additionally, a spiking experiment was conducted with 10 ppm DON, DON-S A, DON-S B standard solutions and individual Motiv ingredients (OA syrup, Motiv syrup, and Motiv product). A percent recovery of LC-detected DON and DON-S molecules was determined.

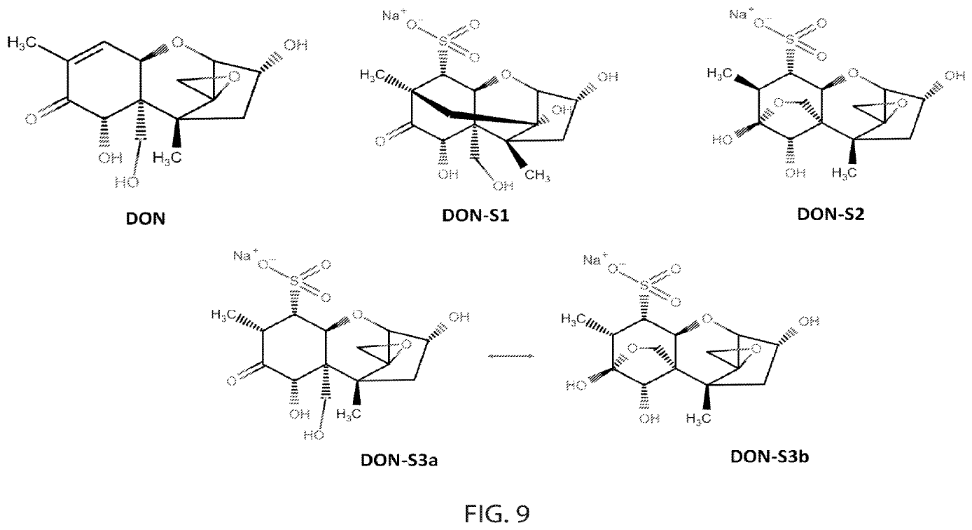

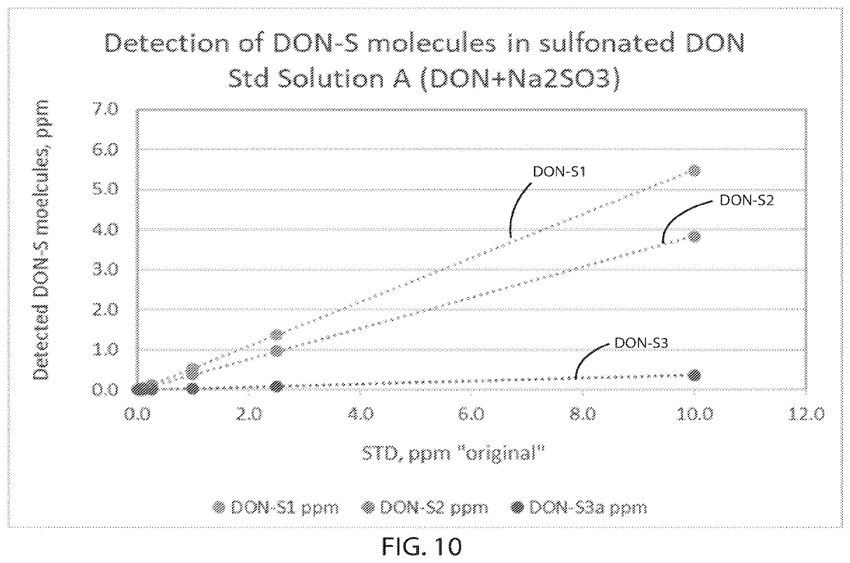

Results and Discussion: When evaluating the two-standard solutions (A and B) of DON sulfonates by LC-MS, several types of DON-S molecules were detected. DON-S A standard solution (prepared via treating DON with sodium sulfites) showed the presence of three predominant sulfonated DON molecules 1, 2, and 3a (see FIG. 9 for structures) at 54.8%, 38.3% and 3.8% distributions (relative area), respectively, while the remaining 3.1% corresponded to 8 additional forms of sulfonated DON (regression of three DON-S species presented in FIG. 10).

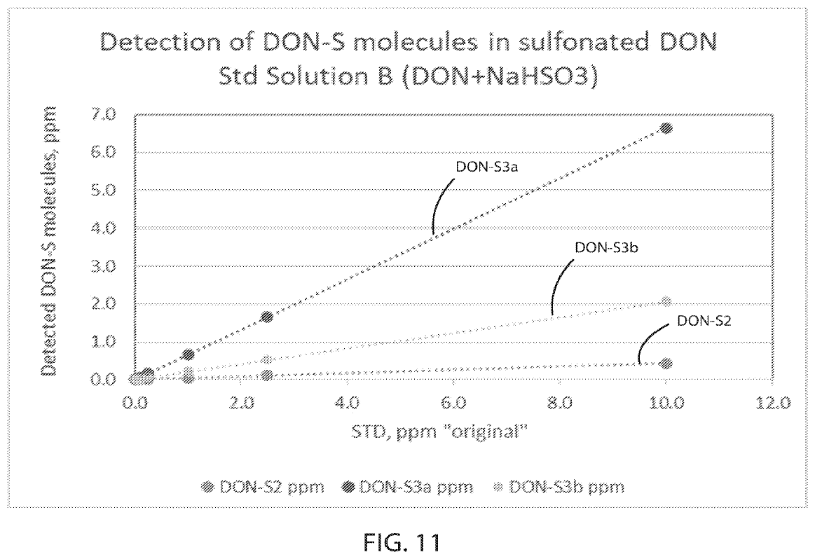

Similarly, DON-S B standard solution (prepared via treating DON with sodium bisulfite) showed the presence of three predominant sulfonated DON molecules 2, 3a, & 3b (see FIG. 9 for structures) at 4.3%, 66.4% and 20.7% distributions (relative area), respectively, while the remaining 8.6% corresponded to five forms of sulfonated DON (FIG. 11).

In both cases, as we dilute the standard solutions A & B, the various forms of DON-S concentrations dropped in a linear regression as compared to the as-is original DON concentration, indicating a proportional recovery of treated DON.

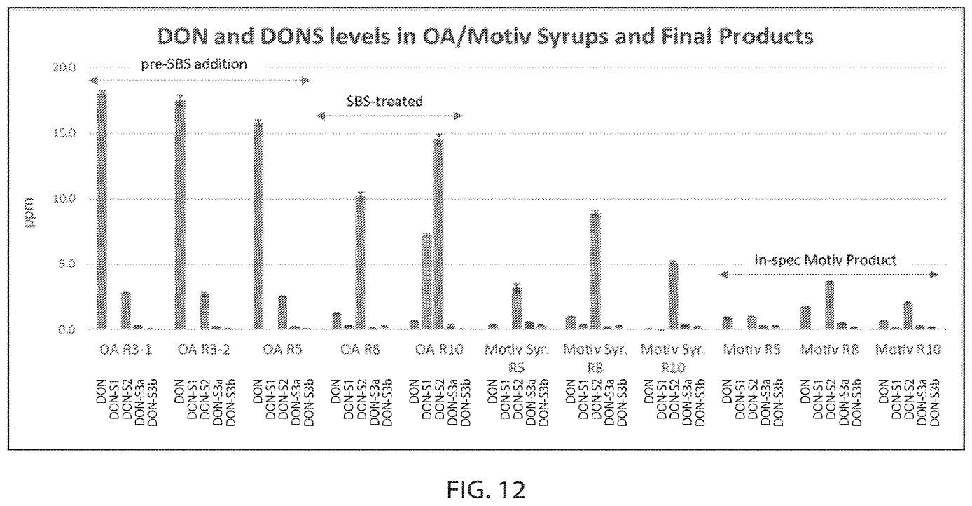

When evaluating the various ingredients of the Motiv process (OA syrups, treated or non-treated with SBS, Motiv Syrup, and Final Motiv products) for DON sulfonates on LC-MS, all four forms of DON-S molecules were detected (DON-S1, -S2, -S3a, & -S3b-FIG. 12). OA syrups from Motiv runs R3 and R5 showed a 15-18 ppm DON level prior to SBS treatment (with a carryover of ~2.7 ppm DON-S2 from steeping process). This elevated DON level dropped to <1.2 ppm level in R8 and R10 SBS-treated OA syrups where DON-S2 was predominantly detected at 10-15 ppm range (with DON-S1 present in R10 OA syrup).

Due to some limitations on sampling, there was no matched pairs of OA syrup pre and post treatment. Only pre-treated samples (R5) have ~16 ppm of DON and DON-S2 but only 3-4 ppm combined in R5 Motiv syrup, indicating some loss due to other mechanisms (degradation or else).

Similarly, Motiv syrups showed a wide range of DON-S2 detection between 3-9 ppm for the three Motiv runs (R5, R8, and R10). In final Motiv products, a further reduction in DON to <1.7 ppm (upon SBS treatment) and in DON-S2 to <3.6 ppm was detected (mainly due to sulfonation chemistry, some sort of DON-S degradation, and E75 inclusion in the co-drying step), where E75 is shorthand for Empyreal® 75. Empyreal® 75 is a highly digestible protein concentrate derived from corn, with a minimum of 75% crude protein, 2% crude fat, and a maximum of 2.5% crude fiber and 1% starch.

Total DON-S was also determined by combining all four forms of DON-S. Total DON-S ppm=DON-S1 ppm+DON-S2 ppm+DON-S3a ppm+DON-S3b ppm.

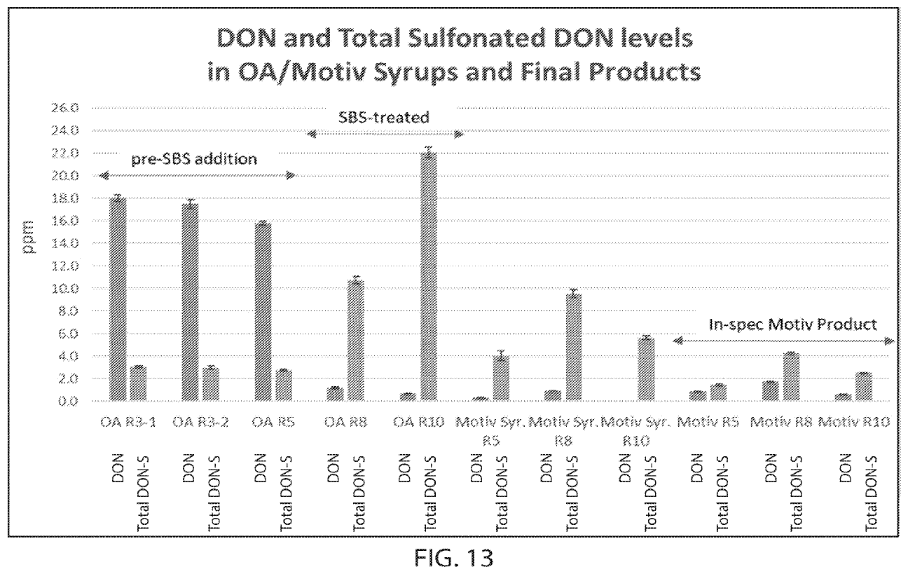

FIG. 13 shows that the total DON-S level fluctuated between 10-22 ppm in OA syrups, 4-10 ppm in Motiv syrups, and 2-4 in final Motiv product. The elevated DON-S level in final product was due to the SBS addition to OA syrup that maintained DON below specification level (<2 ppm).

Degradation of sulfonated DON may have taken place in R5 & R10 Motiv syrups, as compared to their corresponding OA syrups (drop from 16 to 4 ppm and from 22 to 6 ppm, respectively), while other minor species may have been generated. This was not the case in R8 syrups, where the total sulfonated DON dropped from 10 ppm in OA syrup to 9 ppm in Motiv syrup (due to the Biolys incorporation). This phenomenon led to a higher total sulfonated DON in the final R8 Motiv product (3.6 ppm).

Conclusions for Example 3: DON presence in solution over regulatory levels can be an issue, and SBS addition was shown to be the solution for Motiv production and DON reduction to meet product specifications (<2 ppm DON).

Four major forms of DON-S molecules (DON-S1, -S2, -S3a, & -S3b) were detected on LC-MS in the standard solutions and Motiv ingredients upon sulfonation of DON. DON-S2 was the most abundant form in all cases and makes up to 65-95% of the total DON-S detected. Other minor forms of sulfonated DON were also detected (up to 8 additional types).

Higher sulfonated-DON contents were present in OA syrups, as compared to other Motiv ingredients, but seem to drop over time in Motiv syrups and final Motiv product due to some degradation process.

### ADDITIONAL EXAMPLES

The following are additional non-limiting examples of the invention.

Example 1. A feed ingredient, comprising: one or more organic acids, one or more proteins, less than 10 ppm of mycotoxins based on total weight of the feed ingredient, at least 0.1 ppm of sulfonated mycotoxins and derivatives thereof based on total weight of the feed ingredient, and optionally degradation compounds of the sulfonated mycotoxins.

Example 2. The feed ingredient according to example 1, wherein the one or more proteins comprise or essentially consist of corn protein.

Example 3. The feed ingredient according to example 1 or 2, wherein the one or more proteins comprise or essentially consist of fermented corn protein.

Example 4. The feed ingredient according to any one of the preceding examples, wherein the mycotoxins are deoxynivalenol (DON) and the sulfonated mycotoxins are sulfonated deoxynivalenol (DON-S).

Example 5. The feed ingredient according to any one of the preceding examples, wherein the feed ingredient has less than 5 ppm, or less than 2 ppm, preferably less than 1.5 ppm, preferably less than 1 ppm, more preferably less than 0.5 ppm of mycotoxin, in particular of DON, based on total weight of the feed ingredient.

Example 6. The feed ingredient according to any one of the preceding examples, wherein the feed ingredient has at least 0.2 ppm, or at least 0.5 ppm, or at least 1 ppm, or at least 2 ppm of sulfonated mycotoxins and derivatives thereof, in particular of DON-S and derivatives thereof, based on total weight of the feed ingredient.

Example 7. The feed ingredient according to any one of the preceding examples, wherein the feed ingredient has degradation compounds of the sulfonated mycotoxins, in particular of DON-S.

Example 8. The feed ingredient according to any one of the preceding examples, wherein DON-S comprise one or both of compounds (a) and (b):

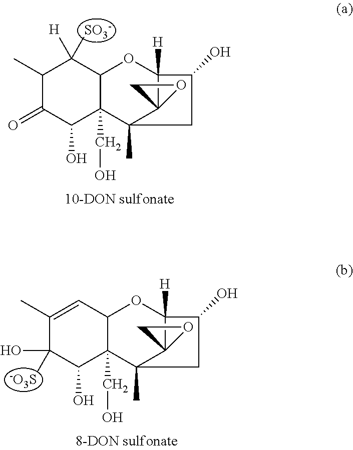

Example 9. The feed ingredient according to any one of the preceding examples wherein the degradation compounds of DON-S are selected from one or more of the following:

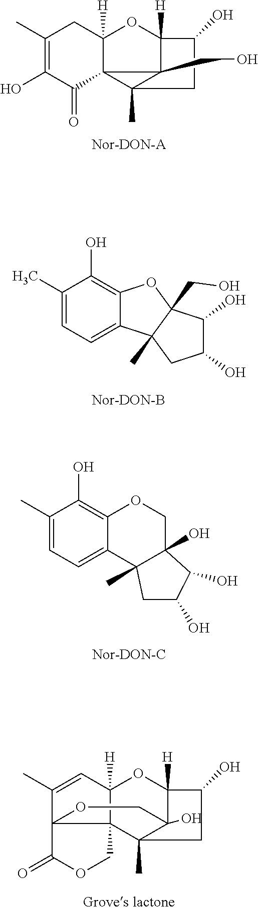

Example 10. The feed ingredient according to any one of the preceding examples, wherein the feed ingredient further comprises phosphorus and phytic acid.

Example 11. The feed ingredient according to any one of the preceding examples, wherein the feed ingredient is at least 40 percent dry solids.

Example 12. The feed ingredient according to any one of examples 1 to 10, wherein the feed ingredient has at most 10 wt percent water.

Example 13. A feed product, comprising: a feed ingredient according to any one of the preceding examples.

Example 14. The feed product of example 13, further comprising corn protein concentrate.

Example 15. The feed product of any of examples 13-14, further comprising corn gluten meal.

Example 16. The feed product of any of examples 13-15, wherein the phytic acid content is less than 0.6 wt percent dry basis.

Example 17. The feed product of any of examples 13-16, comprising 72 to 76 wt percent protein dry basis and/or comprising 6.2 to 7.6 wt percent lactic acid dry basis.

Example 18. The feed product of any of examples 13-17, comprising 3.0 to 3.6 wt percent lysine dry basis.

Example 19. The feed product of any of examples 13-18, having a moisture content of less than 9 percent.

Example 20. A feed diet, comprising the feed ingredient of any of examples 1-12 or the feed product of any of examples 13-19.

Example 21. A feed diet, comprising 2 to 24 percent of the feed product of any of examples 13-19.

Example 22. The feed diet of example 21, comprising 10 to 14 percent of the feed product of any of examples 13-19.

Example 23. The feed diet of any of examples 20-22, further comprising a fat.

Example 24. The feed ingredient, feed product, or feed diet of any one of examples 1-23, wherein the feed ingredient, feed product or feed diet is suitable for feeding an aquatic animal.

Example 25. The feed ingredient, product, or diet of example 24, wherein the aquatic animal is a shrimp.

Example 26. A process for producing a feed ingredient according to any one of examples 1 to 12, comprising: providing a fermentation medium comprising one or more proteins and one or more sugars, fermenting the fermentation medium to produce one or more organic acids, optionally adjusting the pH of the fermentation medium during fermentation, optionally adjusting the temperature of the fermentation medium during fermentation, optionally treating the fermentation medium to reduce an anti-nutritional factor (ANF), treating the fermentation medium with a source of bisulfite ions to carry out a sulfonation treatment, concentrating the fermentation medium, and obtaining the feed ingredient.

Example 27. The process of example 26, wherein the SO₂ concentration in the fermentation medium during the sulfonation treatment with a bisulfite ion source can be from 1200 to 3000 ppm.

Example 28. The process of example 26 or 27, wherein source of bisulfite ions is selected from sodium bisulfite, potassium bisulfite, calcium bisulfite, ammonium bisulfite or any combination thereof.

Example 29. The process of any one of examples 26-28, wherein the source of bisulfite ions is sodium bisulfite at a concentration of from 10 wt % to 44 wt %, preferably from 40 wt % to 42 wt % when added to the fermentation medium.

Example 30. The process of any one of examples 26-29, wherein the sulfonation treatment is carried out for a duration of 3 to 48 hours, preferably 6 to 24 hours, more preferably 12 to 20 hours, most preferably 16 to 18 hours.

Example 31. The process any one of examples 26-30, wherein the pH of the fermentation medium during the sulfonation treatment is from 4.0 to 6.5, preferably 4.2 to 6.0, more preferably 4.5 to 5.5, most preferably 4.8 to 5.0.

Example 32. The process any one of examples 26-31, wherein the concentration of solids in the fermentation medium is about 9 to 17 percent prior to fermentation and/or wherein the concentration of solids in the concentrated fermentation medium is about 40 to 60 percent post evaporation.

Example 33. The process of any one of examples 26-32, wherein the fermentation medium is a corn mill stream.

Example 34. The process of any one of examples 26-33, wherein the one or more organic acids are selected from the group consisting of lactic acid, formic acid, propionic acid, fumaric acid, citric acid, butyric acid, gluconic acid, itaconic acid, pyruvic acid, salts thereof, and any combination of these organic acids or salts thereof.

Example 35. The process of any one of examples 26-34, further comprising adding a fermentation medium to the feed ingredients.

Example 36. The process of any one of examples 26-35, wherein the feed component is an intermediate mill stream or an intermediate fermentation stream.

Example 37. The process of any one of examples 26-36, wherein the feed component comprises an amino acid.

Example 38. The process of any one of examples 26-37, wherein the feed component comprises lysine.

Example 39. The process of any one of examples 26-38, wherein concentrating the fermentation medium comprises an evaporation step.

Example 40. The process of example 39, wherein the evaporation step increases the concentration of solids in the feed ingredient or fermentation medium to about 40 to 60 wt percent. Example 41. The process of any one of examples 26-40, further comprising combining the feed ingredient with a protein concentrate to form a feed product.

Example 42. The process of example 41, wherein the protein concentrate comprises corn protein. Example 43. The process of any one of examples 26-42, further comprising a drying step.

Example 44. The process of example 43, wherein the moisture content of the feed ingredient or feed product is less than 9 percent after the drying step.

Example 45. The process of any one of examples 26-44, wherein the ANF reduction step comprises a phytase treatment.

Example 46. The process example 45, wherein the phytase treatment increases the bioavailable phosphorus content of the feed product.

Example 47. The process of any one of examples 26-46, wherein the fermentation medium is fermented using a microorganism endogenous to the fermentation medium.

Example 48. The process of any one of examples 26-47, further comprising inoculating the fermentation medium with a microorganism.

Example 49. The process of example 48, wherein the fermentation medium is sterilized or pasteurized prior to inoculating.

Example 50. The process of example 48 or 49, wherein the microorganism is of a genus selected from the group consisting of Lactobacillus, Leuconostoc, Acetobacter, Aspergillus, Bacillus, Brevibacterium, Clostridium, Corynebacterium, Micrococcus, Penicillium, Rhizopus, and Saccharomyces.

Example 51. The process of any of examples 26-50, wherein the feed ingredient or feed product is the feed ingredient or feed product of any of examples 1-25.

Example 52. A feed ingredient or feed product obtained from the process of any one of examples 26 to 51.

Example 53. A method for feeding an animal comprising administering the feed ingredient, feed product, or feed diet of any of examples 1-25.

Example 54. The method of example 53, wherein the animal is a shrimp.

Example 55. Use of a bisulfite ion source to sulfonate mycotoxins in a fermented feed composition.

Example 56. The use according to example 55, wherein the fermented feed composition is a fermented vegetable protein composition.

Example 57. The use according to example 56, wherein the fermented vegetable protein composition is a fermented corn protein composition.

Example 58. The use according to example 57, wherein the fermented corn protein composition comprises at least 50 wt % of corn protein on a dry basis.

1. A feed ingredient, comprising:
one or more organic acids,
one or more proteins,
less than 10 ppm of mycotoxins based on total weight of the feed ingredient, and
at least 0.1 ppm of sulfonated mycotoxins and derivatives thereof based on total weight of the feed ingredient.

2. The feed ingredient according to claim 1, wherein the one or more proteins comprise corn protein.

3. The feed ingredient according to claim 1, wherein the one or more proteins comprise fermented corn protein.

4. The feed ingredient according to claim 1, wherein the mycotoxins are deoxynivalenol (DON) and the sulfonated mycotoxins are sulfonated deoxynivalenol (DON-S).

5. The feed ingredient according to claim 1, wherein the feed ingredient has less than 5 ppm of mycotoxin based on total weight of the feed ingredient.

6. The feed ingredient according to claim 1, wherein the feed ingredient has at least 0.2 ppm of sulfonated mycotoxins and derivatives thereof based on total weight of the feed ingredient.

7. The feed ingredient according to claim 1, wherein the feed ingredient comprises degradation compounds of the sulfonated mycotoxins.

8. The feed ingredient according to claim 1, wherein the sulfonated mycotoxins comprise one or both of compounds (a) and (b):

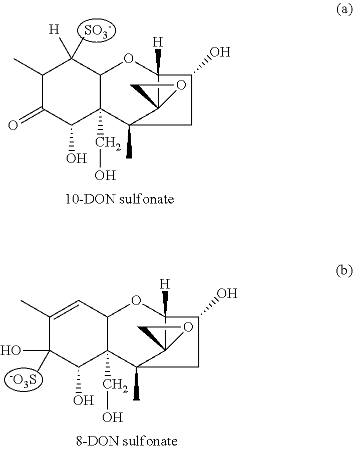

9. The feed ingredient according to claim 7, wherein the degradation compounds of the sulfonated mycotoxins are selected from one or more of the following:

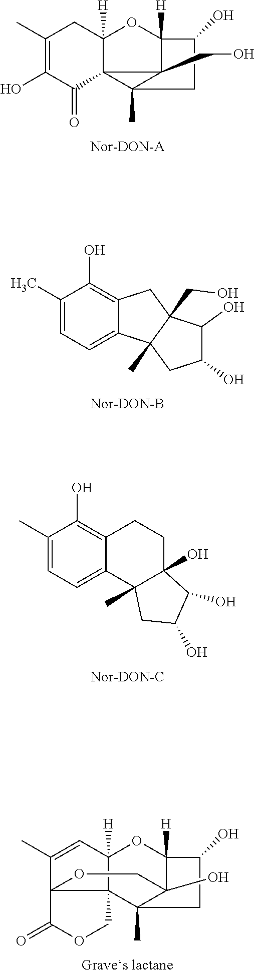

10. The feed ingredient according to claim 1, wherein the feed ingredient further comprises phosphorus and phytic acid.

11. The feed ingredient according to claim 1, wherein the feed ingredient is at least 40 percent dry solids.

12. A feed product, comprising: a feed ingredient according to claim 1 and wherein the feed product comprises 72 to 76 wt percent protein dry basis and 6.2 to 7.6 wt percent lactic acid dry basis.

13. A feed diet, comprising 2 to 24 percent of the feed product of claim 12.

14. A method for feeding an animal comprising administering the feed ingredient of claim 1.

15. (canceled)
